(19) United States
(12) Patent Application Publication
(10) Pub. No.: US 2005/0104844 A1
(43) Pub. Date: May 19, 2005

(54) Electrophoretic display device and method of driving electrophoretic display device

(76) Inventors: Yutaka Nakai, Yokohama-shi (JP); Hideyuki Nakao, Tokyo (JP); Shintaro Enomoto, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/950,426

(22) Filed: Sep. 28, 2004

(30) Foreign Application Priority Data
Sep. 30, 2003 (JP) 2003-342230

(51) Int. Cl. G09G 3/04

(52) U.S. Cl. 345/107

(57) ABSTRACT

An electrophoretic display device comprises substrates faced to each other so as to form a pixel space therebetween. A first electrode group including control electrode segments is formed on the substrate, and a second electrode group including a counter electrode segment is formed on the substrate. A dispersion liquid of colored and charged fine particles dispersed in an insulating liquid is charged in the pixel space. The fine particles are collected on the first and second electrode groups so as to permit different colors to be displayed on the pixel. A first voltage is applied to a control electrode segment and a second voltage applied to the other control electrode segments so as to cause the colored and charged fine particles to be migrated at a uniform migration speed to the control electrode segments, thereby collecting the colored and charged fine particles on the control electrode segments.

### CROSS-REFERENCE TO RELATED APPLICATIONS

This application is based upon and claims the benefit of priority from prior Japanese Patent Application No. 2003-342230, filed Sep. 30, 2003, the entire contents of which are incorporated herein by reference.

### BACKGROUND OF THE INVENTION

1. Field of the Invention

The present invention relates to an electrophoretic display device and a method of driving the electrophoretic display device, particularly, to an electrophoretic display device capable of a stable display and a method of driving the particular electrophoretic display device.

2. Description of the Related Art

Various types of display devices have been developed to date. In recent years, attentions have been paid to a reflection type display device in view of the requirement for the reduction of the power consumption and the requirement for alleviating eyestrain. An electrophoretic display device as disclosed in U.S. Pat. No. 3,668,106 is known to the art as a reflection type display device. The electrophoretic display device disclosed in the U.S. Patent document quoted above comprises a pair of electrodes arranged to face each other with a gap provided therebetween and a dispersion liquid loaded in the gap between the electrodes. The dispersion liquid used in the electrophoretic display device comprises electrophoretic fine particles having an electrical charge and an insulating liquid having the electrophoretic fine particles dispersed therein. In the electrophoretic display device disclosed in the U.S. Patent document quoted above, one of the contrasting colors is displayed under the state that an electric field is not applied across the dispersion liquid layer loaded in the gap between the paired electrodes. On the other hand, if an electric field is applied across the dispersion liquid layer through the paired electrodes, the electrophoretic fine particles are migrated onto the electrode having a polarity opposite to that of the electric charge of the electrophoretic fine particles, with the result that the other color of the contrasting colors is displayed.

One of the contrasting colors of the electrophoretic fine particles corresponds to the color of the insulating liquid having a coloring matter dissolved therein. To be more specific, where the electrophoretic fine particles are attached to the surface of a transparent first electrode positioned closer to the observer, the color of the electrophoretic fine particles is observed. On the other hand, where the electrophoretic fine particles are attached to the surface of a second electrode positioned remoter from the observer, the color of the electrophoretic fine particles is shielded by the insulating liquid, with the result that the color of the insulating liquid is observed through the transparent first electrode. It should be noted that the electrophoretic display device is advantageous in its wide viewing angle, in its high contrast, and in its low power consumption, as described in (“Optical Characteristics of Electrophoretic Displays”, Proc. SID, 18,267 (1977)).

However, this kind of the electrophoretic display device gives rise a difficulty that both a high reflectance, i.e., a sufficient brightness, and a high contrast cannot be satisfied simultaneously because, for example, the coloring matter dissolved in the insulating liquid is adsorbed on the electrophoretic fine particles, or the insulating liquid permeates into the region between the surface of the electrode having the electrophoretic fine particles adsorbed thereon and the electrophoretic fine particles.

In order to overcome the drawback pointed out above, an electrophoretic display device using a transparent insulating liquid is proposed in, for example, Japanese Patent Disclosure (Kokai) No. 9-211499, Japanese Patent Disclosure No. 11-202804, or “S. A. Swanson, ‘High Performance Electrophoretic Displays.’ SID' 00 Digest, p. 29 (2000)”. In order to display a black color in the system disclosed in each of these publications, colored particles are migrated by the electrophoretic effect onto a transparent pixel electrode of a size substantially equal to the pixel size. On the other hand, for displaying a white color, the colored particles are collected in the non-pixel portion or on the pixel having a small area so as to form a light transmitting state in the pixel portion. In this case, a coloring matter is not dissolved in the insulating liquid so as to improve the stability of the dispersion liquid. Also, a good white display can be achieved by controlling the scattering characteristics of the reflecting electrode.

The description given above is directed to display devices for displaying two colors. However, a display device capable of displaying an intermediate color tone as well as two colors is also being proposed. For example, an idea of modulating the pulse width of the driving voltage for allowing each pixel to display an intermediate color tone is proposed in, for example, “R. M. Webber, ‘Image Stability in Active-Matrix Microencapsulated Electrophoretic Displays’ SID02′ Digest, p. 126 (2002)”. In the electrophoretic display device disclosed in “R. M. Webber, ‘Image Stability in Active-Matrix Microencapsulated Electrophoretic Displays’ SID02′ Digest, p. 126 (2002)”, white electrophoretic fine particles and black electrophoretic fine particles are dispersed in a transparent solvent so as to form a dispersion liquid, and the dispersion liquid containing the white electrophoretic fine particles and the black electrophoretic fine particles are sealed in a microcapsule. Also, the display device disclosed in “R. M. Webber, ‘Image Stability in Active-Matrix Microencapsulated Electrophoretic Displays’ SID02′ Digest, p. 126 (2002)” comprises a transparent common electrode, and a plurality of pixel electrodes arranged to face the common electrode with a free space provided therebetween. In addition, pluralities of microcapsules are arranged in the free space in a manner to face the corresponding pixel electrodes. When an intermediate color tone is displayed, the particles are once collected on the side of the common electrode so as to control the pulse width of the driving voltage applied to the pixel electrodes. For example, where the driving voltage having a pulse width of 0 is applied to the pixel electrodes under the state that the black particles are collected first on the electrode on the side of the observer, i.e., where the driving voltage is not applied, the black particles remain on the electrode so as to permit the capsules to be displayed as a black color. On the other hand, if a driving voltage having a sufficiently large pulse width is applied to the pixel electrodes under the state that the black particles remain on the common electrode on the side of the observer, the black particles are migrated toward the pixel electrodes and the white particles are migrated toward the common electrode on the side of the observer, with the result that a white color is displayed. Where a driving voltage having an intermediate pulse width is applied to the pixel electrodes, the white particles and the black particles remain at an intermediate position within the capsule. It follows that a mixed state of the white particles and the black particles is observed from the side of the observer, with the result that an intermediate color tone is displayed.

Further, a display device capable of displaying an intermediate color tone is disclosed in “Y. Matsuda, ‘Newly designed, high resolution, active-matrix addressing in-plane EPD’ IDW'02, p. 1341 (2002)”. In the display device disclosed in “Y. Matsuda, ‘Newly designed, high resolution, active-matrix addressing in-plane EPD’ IDW'02, p. 1341 (2002)”, the value of the driving voltage is modulated so as to display the intermediate color tone. In this display device, the display section is partitioned into a column of chambers corresponding to the pixels. The pixel electrode is embedded in the bottom wall portion of each chamber, and a peripheral electrode is formed in the sidewall of each chamber. A transparent solvent is loaded in each chamber, and black electrophoretic fine particles are dispersed in the transparent solvent. In this display device, the black particles are once collected on the peripheral electrode, and the black particles are spread depending on the value of the driving voltage applied to the pixel electrode so as to display the intermediate color tone. Where the value of the driving voltage is 0V, the black particles are kept attracted to the peripheral electrode, and the migration of the black particles toward the bottom portion of each chamber is not generated. It follows that the white color, which is the color of the bottom portion of the chamber, is displayed as the pixel color, and the white display is continued. Also, if a sufficiently high driving voltage is applied to the pixel electrode, the black particles are attracted to the pixel electrode, and the black particles are migrated to the bottom portion of each chamber. As a result, the black particles are sufficiently spread in the bottom portion of each chamber so as to permit the black pixel to be displayed. Further, if a driving voltage of an intermediate level is applied to the pixel electrode, the black particles are spread to an intermediate region in the bottom portion of each chamber and remain in the intermediate region noted above, with the result that an intermediate color tone is displayed as the pixel.

In the display device disclosed in each of Japanese Patent Disclosure No. 9-211499, Japanese Patent Disclosure No. 11-202804 and “S. A. Swanson, ‘High Performance Electrophoretic Displays.’ SID' 00 Digest, p. 29 (2000)”, the electrodes differ from each other in area, or are not positioned to face each other. As a result, the electric field generated between the electrodes is not uniform, so as to generate a strong electric field region and a weak electric field region. It follows that, when voltage is applied between the two electrodes so as to permit the particles to be migrated by the electrophoretic effect, the response of the particles is rendered poor in the weak electric field region, though the particles are migrated at a high speed within the strong electric field region. Such being the situation, the overall response speed of the particles is lowered. Further, the spreading of the particles into the pixel is rendered non-uniform in the display stage of the black color so as to give rise to the problem that the contrast is lowered.

The electrophoretic display device that permits displaying an intermediate color tone is disclosed in “R. M. Webber, ‘Image Stability in Active-Matrix Microencapsulated Electrophoretic Displays’ SID02′ Digest, p. 126 (2002)”, as pointed out previously. In the electrophoretic display device disclosed in this publication, the pulse width of the driving voltage or the voltage value is modulated so as to control the migration distance of the electrophoretic fine particles. In this display device, however, the electrophoretic fine particles are significantly non-uniform in the electrophoretic characteristics so as to give rise to the problem that it is impossible to achieve a stable display of the intermediate color tone.

Further, the electrophoretic fine particles are significantly non-uniform in the electrophoretic characteristics, also in the display device disclosed in “Y. Matsuda, ‘Newly designed, high resolution, active-matrix addressing in-plane EPD’ IDW'02, p. 1341 (2002)”. As a result, a difficulty is brought about that the electrophoretic fine particles are rendered widely different from each other in the migration distance even if the driving signal is modulated, leading to the problem that the different intermediate color tone characteristics are generated depending on the site.

### BRIEF SUMMARY OF THE INVENTION

An object of the present invention is to provide an electrophoretic display device capable of achieving an image display of an intermediate color tone with a high stability and with an excellent controllability.

According to a first aspect of the present invention, there is provided an electrophoretic display device, comprising:
a first substrate;
a second substrate arranged to face the first substrate with a gap therebetween;
a dispersion liquid including an insulating liquid and electrophoretic fine particles dispersed in an insulating liquid, the dispersion liquid being applied in the gap;
first and second control electrode segments formed on the first substrate;
a counter electrode segment formed on the second substrate; and
a voltage applying circuit configured to apply a voltage to the control electrode segments and the counter electrode segment so as to produce first and second potential changes on the first and second control electrode segments, respectively.

According to a second aspect of the present invention, there is provided an electrophoretic display device, comprising:
a first substrate;
a second substrate arranged to face the first substrate with a gap therebetween;
a dispersion liquid including an insulating liquid and electrophoretic fine particles dispersed in the insulating liquid, the dispersion liquid being applied in the gap;
first and second control electrode segments formed on the first substrate;
a counter electrode segment formed on the second substrate; and
a voltage applying circuit configured to apply a voltage to the control electrode segments and the counter electrode segment so as to produce first and second potential changes on the first and second control electrode segments, respectively, the voltage applying circuit including:
first and second impedance elements having first and second impedances and connected to the first and second control electrode segments, respectively;
a first switching element connected to the first and second control electrode segments through the first and second impedance elements;
a switching control section configured to control the switching element; and
a voltage source for applying voltage between the first and second control electrode segments and the counter electrode segment via the switching element and the first and second impedance elements.

Further, according to a third aspect of the present invention, there is provided a method of driving an electrophoretic display device, the electrophoretic display device comprising:
a first substrate;
a second substrate arranged to face the first substrate with a gap provided therebetween;
a dispersion liquid including an insulating liquid and electrophoretic fine particles dispersed in the insulating liquid, the dispersion liquid being applied in the gap;
first and second control electrode segments formed on the first substrate; and
a counter electrode segment formed on the second substrate;
the driving method comprising
applying a voltage to the first and second control electrode segments and the counter electrode segment so as to produce first and second potential changes on the first and second control electrode segments.

In the electrophoretic display device of the present invention, the area of the electrode to which the electrophoretic fine particles are attached within each pixel can be modulated so as to make it possible to provide a display medium capable of display of an intermediate color tone with a high stability and with an excellent reproducibility.

Also, the present invention provides an electrophoretic display device in which the response speed can be improved so as to improve the contrast by controlling the electric field generated within the pixel by a simple method.

### BRIEF DESCRIPTION OF THE SEVERAL VIEWS OF THE DRAWING

FIG. 1 is a cross sectional view schematically showing the construction of an electrophoretic display device according to a first embodiment of the present invention;

FIGS. 2A and 2B are plan views schematically showing various shapes of the control electrode segment included in the electrophoretic display device shown in FIG. 1;

FIG. 3 is a cross sectional view schematically showing the construction of an electrophoretic display device according to a second embodiment of the present invention;

FIGS. 4A and 4B are plan views schematically showing various shapes of the control electrode segment included in the electrophoretic display device shown in FIG. 3;

FIG. 5 is a cross sectional view schematically showing the construction of an electrophoretic display device according to a third embodiment of the present invention;

FIG. 6 is a cross sectional view schematically showing the construction of an electrophoretic display device according to a fourth embodiment of the present invention;

FIG. 7 is a cross sectional view schematically showing the construction of an electrophoretic display device for Example 2 of the present invention;

FIG. 8 is a cross sectional view schematically showing the construction of an electrophoretic display device for Example 5 of the present invention;

FIGS. 9A and 9B are cross sectional views schematically showing the method of a binary display of black and white in each pixel included in the display device shown in FIG. 8;

FIGS. 10A and 10B are cross sectional views schematically showing the method of an intermediate color tone display in each-pixel included in the display device shown in FIG. 8;

FIGS. 11A, 11B and 11C show waveforms of the voltage applied to each electrode segment for realizing the display operation shown in FIG. 10B and also show the waveforms denoting the change in potential;

FIG. 12 is a cross sectional view schematically showing the construction of an electrophoretic display device according to a modification of the electrophoretic display device shown in FIG. 8;

FIG. 13 is a cross sectional view schematically showing the construction of an electrophoretic display device according to a seventh embodiment of the present invention;

FIGS. 14A, 14B, 14C, 14D and 14E show the waveforms of the voltage applied to each electrode segment included in the display device shown in FIG. 13 and also show the waveforms denoting the change in potential;

FIGS. 15A, 15B and 15C show waveforms of the voltage applied to each electrode segment for realizing the display operation in the electrophoretic display device according to the seventh embodiment of the present invention and also show the waveforms denoting the change in potential;

FIG. 16A is a cross sectional view schematically showing the construction of the electrophoretic display device according to an eighth embodiment of the present invention;

FIG. 16B is a circuit diagram denoting the resistance circuit element that is incorporated in the electrophoretic display device shown in FIG. 16A;

FIG. 17 schematically shows the construction of the circuit incorporated in the electrophoretic display device shown in FIG. 16A;

FIG. 18 is a circuit diagram schematically showing the construction of the circuit incorporated in the electrophoretic display device according to a ninth embodiment of the present invention;

FIG. 19 shows a circuit diagram schematically showing the construction of the circuit incorporated in the electrophoretic display device according to a tenth embodiment of the present invention;

FIG. 20 is a graph schematically showing the current-voltage characteristics of the circuit shown in FIG. 19;

FIG. 21 is a circuit diagram schematically showing the construction of the circuit incorporated in the electrophoretic display device according to an eleventh embodiment of the present invention; and

FIG. 22 is a graph schematically showing the current-voltage characteristics of the circuit shown in FIG. 21.

### DETAILED DESCRIPTION OF THE INVENTION

Some embodiments of the electrophoretic display device of the present invention will now be described with reference to the accompanying drawings.

### First Embodiment

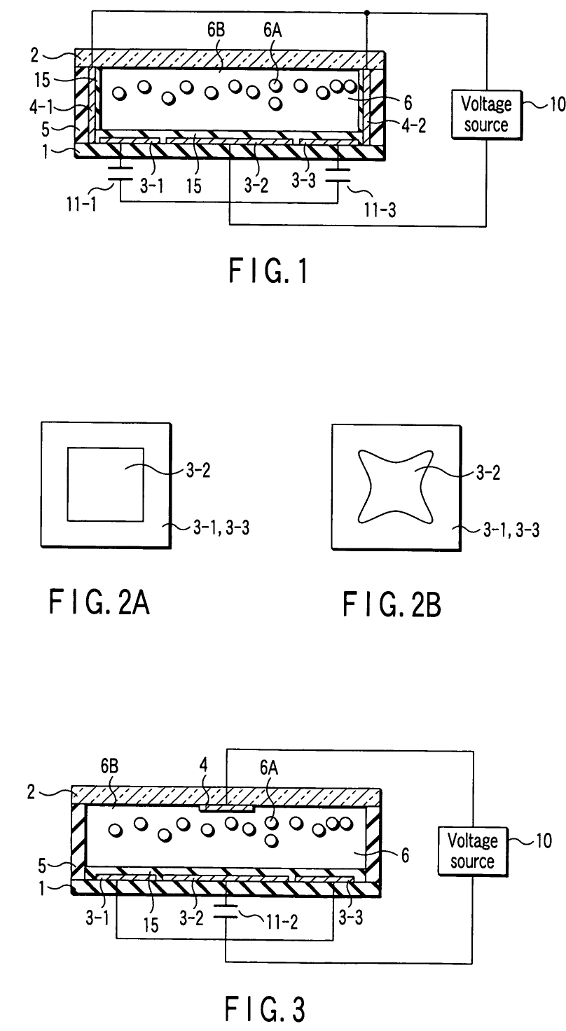

FIG. 1 shows the typical construction of an electrophoretic display device according to a first embodiment of the present invention.

The electrophoretic display device shown in FIG. 1 comprises a dispersion liquid 6 comprising colored fine particles 6A having an electrically charged surface and a transparent insulating liquid 6B having the colored fine particles 6A dispersed therein. The dispersion liquid 6 is loaded in a free space forming a pixel and defined by a first substrate 1, a transparent second substrate 2 positioned to face the first substrate 1 with a gap provided therebetween, and partition walls 5 supporting the first substrate 1 and the second substrate 2. A first electrode group 3 of a first control electrode segment 3-1, a second control electrode segment 3-2 and a third control electrode 3-3, which are independent of each other, is formed on the first substrate 1. FIG. 1 simply shows the construction of only one pixel for simplifying the drawing. However, it is apparent that the pixels of the same construction are arranged to form rows and columns of the pixels in a two dimensional direction so as to form a planar display device.

Incidentally, the first electrode group 3 is formed of three control electrode segments 3-1, 3-2 and 3-3 in the embodiment shown in FIG. 1 for simplification of the description. However, it is apparent that it is possible for the first electrode group 3 to be formed of two control electrode segments or four or more control electrode segments. Also, in the embodiment shown in FIG. 1, the control electrode segments are arranged in symmetry with respect to the center in the vertical direction of the pixel. However, it is not required that the control electrode segments are arranged in symmetry. It is possible to arrange the control electrode segments in various fashions.

A second electrode group 4 of a first counter electrode segment 4-1 and a second counter electrode segment 4-2, which are smaller than the control electrode segments 3-1, 3-2, 3-3, is formed on the partition walls 5. The total area of the second electrode group 4 is defined to be smaller than the total area of the first electrode group 3. An insulating film 15 is formed to cover the first electrode group 3 and the second electrode 4. It is desirable for the insulating film 15 to be formed for controlling the adsorption force for attracting the colored fine particles 6A contained in the insulating liquid 6B toward the electrode segments. However, it is not absolutely necessary to form the insulating film 15. Also, it is possible for the second electrode group 4 to be formed on the second substrate 2, as shown in FIG. 3. It should be noted in this connection that the second electrode group 4 shown in FIG. 3 consists of a single electrode segment.

The second control electrode segment 3-2 of the first electrode group 3 and the counter electrode segments 4-1 and 4-2 of the second electrode group 4 are connected directly to a driving voltage source 10. On the other hand, the first and third control electrode segments 3-1 and 3-3 of the first electrode group 3 are connected to the driving voltage source 10 with capacitors 11-1 and 11-3 interposed therebetween, respectively. The migration of the colored fine particles 6A contained in the insulating liquid 6B is controlled by controlling the voltage applied from the driving voltage source 10 to the electrode groups 3 and 4. To be more specific, the colored fine particles 6A in the insulating liquid 6B are migrated toward the appropriate electrode in accordance with the application of an electric field to the insulating liquid 6B. Where the colored fine particles 6A are migrated to the electrode group 3, the colored fine particles 6A can be observed through the transparent second substrate 2. On the other hand, where the colored fine particles 6A are migrated to the electrode group 4, the surface of the substrate 1 is observed through the transparent second substrate 2. It follows that, if a white reflective body is formed on the first substrate 1, the white color is displayed. Also, if the electrode group 3 is formed of a reflective material, the white color is displayed similarly.

In the arrangement shown in FIG. 1, the distance between the first electrode group 3 and the second electrode group 4 is not uniform. The first electrode group 3 and the second electrode group 4 are positioned close to each other in some portions and are positioned far away from each other in other portions. It follows that, if voltage is applied between the first electrode group 3 and the second electrode group 4, the colored fine particles are migrated at a high speed so as to reach the electrode promptly in the portion where the first electrode group 3 and the second electrode group 4 are positioned close to each other because an electric field having a relatively high intensity is applied to the particular portion noted above. However, an electric field having a low intensity is applied to the portion where the first electrode group 3 and the second electrode group 4 are positioned far away from each other, with the result that the colored fine particles are migrated at a low speed.

To be more specific, the intensity of the electric field formed between the counter electrode segment 4-1 and the first control electrode segment 3-1 is higher than that of the electric field formed between any of the counter electrode segments and the second control electrode segment 3-2. Likewise, the intensity of the electric field formed between the counter electrode segment 4-2 and the third control electrode segment 3-3 is higher than that of the electric field formed between any of the counter electrode segments and the second control electrode segment 3-2. Such being the situation, the capacitors 11-1 and 11-3 are connected to the first and third control electrode segments 3-1 and 3-3, respectively, such that the first and third control electrode segments 3-1 and 3-3 are connected to the voltage source 10 via the capacitors 11-1 and 11-3, respectively. As a result, the voltage drop is generated by the capacitors 11-1 and 11-3. It follows that the voltage lowered by the voltage drop caused by the capacitors 11-1 and 11-3 is applied to the first and third control electrode segments 3-1 and 3-3. Such being the situation, the non-uniformity in the intensity of the electric field is diminished within the entire pixel, with the result that the colored fine particles are migrated within the pixel at a substantially uniform migration speed. It should also be noted that the colored fine particles are not concentrated in a region having an electric field of a high intensity applied thereto. Such being the situation, it is possible to suppress the leakage of the light rays even in the stage of the black color display so as to achieve a display of a high contrast.

It should also be noted that, in the display device shown in FIG. 1, the level of the voltage applied to the first and third control electrode segments 3-1 and 3-3 differs from that of the voltage applied to the second control electrode segment 3-2. As a result, an electric field is also generated between the first control electrode segment 3-1 and the second control electrode segment 3-2 and between the third control electrode segment 3-3 and the second control electrode 3-2. The electric field thus generated permits further promoting the migration of the colored fine particles 6A.

Incidentally, as described herein later, it is possible to apply the controlled voltage from independent voltage sources to the control electrode segments 3-1, 3-2, 3-3 of the first electrode group 3. In this case, however, it is necessary to prepare a plurality of voltage sources and wirings, with the result that the construction of the apparatus is rendered complex. When it comes to the connection shown in FIG. 1, the voltage source and the wiring to each pixel need not be changed, and a circuit for applying different voltages to the control electrode segments can be achieved easily by simply mounting the capacitors.

Also, in the arrangement shown in FIG. 1, the control electrode segments 3-1, 3-2, 3-3 are arranged electrically independent of each other so as to form a planar arrangement. What should be noted in this connection is that a clearance is provided between the adjacent control electrode segments. Under the display state of the colored image, the colored fine particles 6A are not sufficiently collected in the clearance region, with the result that it is possible for the clearance region not to be colored so as to cause the light rays to be transmitted through the clearance region. If the particular clearance region is generated, the contrast tends to be lowered. In order to prevent the leakage of the light rays through the clearance region between the adjacent control electrode segments, it is advisable to arrange a light shielding material in the clearance region between the adjacent control electrode segments so as to shield the light rays passing through the clearance region. It is possible to arrange the light shielding material for shielding the light rays running toward the clearance region between the adjacent control electrode segments on the side of the first substrate 1 or on the side of the second substrate 2. Also, since the colored fine particles are also adsorbed on a region slightly deviated from the electrode, it is possible to prevent the contrast from being lowered by diminishing sufficiently the free space region between the adjacent control electrode segments so as to permit the colored fine particles to be adsorbed in substantially the region slightly deviated from the electrode.

Further, in manufacturing the display device of the construction described above, it is desirable for the pixel to be used in an active matrix type display device that is connected to a switching element formed of, for example, a thin film transistor because it is possible for the active matrix type display device of this type to achieve a good contrast and a satisfactory response speed. However, a simple matrix type display device can also be achieved easily by arranging separately a wiring on the side of the first substrate.

As shown in FIG. 2A, it is possible for the first and third control electrode segments 3-1 and 3-3 to be formed integral in the shape of a rectangular frame. In the construction shown in FIG. 1, the first and second counter electrode segments 4-1 and 4-2 collectively constituting the second electrode group 4 are arranged in the periphery of the pixel, with the result that the intensity of the electric field is increased in the peripheral portion of the pixel. It follows that the integral rectangular frame-like control electrode segments 3-1 and 3-3 are arranged in the periphery of the pixel, and the capacitors are connected between the control electrode segments 3-1, 3-3 and the voltage source. On the other hand, the second control electrode segment 3-2 is formed square and arranged within the frame-like control electrode segments 3-1 and 3-3. Each of the control electrode segments 3-1, 3-2 and 3-3 need not have linear inner and outer edges. It is possible for each of these control electrode segments to have curved inner and outer edges, as shown in FIG. 2B.

Incidentally, in the display device shown in FIG. 1, the capacitors 11-1 and 11-2 are connected as impedance elements to the first and third control electrode segments 3-1 and 3-3, respectively. However, in the actual display device, impedance such as a stray capacitance is imparted to the line connected to the second control electrode segment 3-2. For example, impedance such as the resistance and the stray capacitance between the second control electrode segment 3-2 and the counter electrode segments 4-1, 4-2 is imparted to the line connected to the second control electrode segment 3-2. It follows that an impedance element such as a capacitor is connected also to the second control electrode segment 3-2 as well as to the first and third control electrode segments 3-1 and 3-3, and the control electrode segments are designed to be different from each other in, for example, the capacitance. In the following description, it is assumed that, even in the case where a resistor or a capacitor shown in the drawing as an active element is connected to a specified electrode segment, a line resistance or a stray capacitance, which is not shown in the drawing, is imparted to the other electrode segments.

### Second Embodiment

FIG. 3 schematically shows the construction of an electrophoretic display device according to a second embodiment of the present invention.

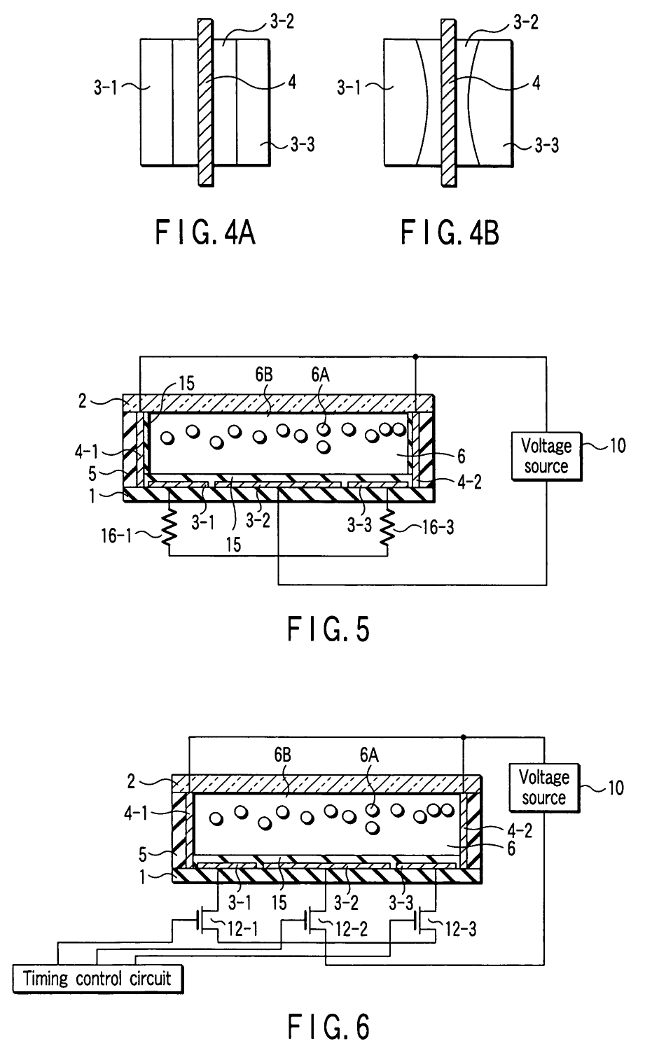

The display device shown in FIG. 3 differs from the display device shown in FIG. 1 in that a second electrode group 4 of a single counter electrode segment having an area smaller than that of each of the control electrode segments 3-1, 3-2, and 3-3 is formed on a substrate 2 in a manner to face a substrate 1 with a gap provided therebetween. As shown in FIGS. 4A and 4B, the second electrode group 4 is arranged to cross linearly the pixel. In the construction shown in FIG. 3, the counter electrode segment of the second electrode group 4 extends through the central region of the pixel. However, it is not absolutely necessary for the counter electrode segment noted above to extend through the central region of the pixel. It is possible for the counter electrode segment noted above to extend through the peripheral region of the pixel. Also, the counter electrode segment of the second electrode group 4 is not limited to the electrode segment of a stripe shape that extends linearly. It is also possible for the counter electrode segment of the second electrode group 4 to extend in a curved or folded configuration.

In the construction shown in FIG. 3, an electric field having the highest intensity is formed in the region right under the second electrode group 4. Such being the situation, a capacitor 11-2 is connected between the second control electrode segment 3-2 positioned right under the second electrode group 4 and the voltage source 10. By the connection of the capacitor 11-2, the potential of the second control electrode segment 3-2 can be relatively lowered, compared with the potential of each of the other control electrode segments. As a result, the distribution in the intensity of the electric field can be made uniform within the pixel so as to make it possible for the colored fine particles to be migrated at a uniform migration speed within the pixel. It is desirable for the optimum value of the voltage applied to the second control electrode segment 3-2, which is determined in accordance with, for example, the gap between the substrates and the area of the pixel, to fall within a range of between 60% and 90% of the voltage applied to each of the control electrode segments 3-1 and 3-3.

As shown in FIG. 4A, it is possible to arrange the linear second control electrode segment 3-2 right under the second electrode group 4 and to arrange the first and third linear control electrode segments 3-1 and 3-3 on both sides of the second control electrode segment 3-2. It is also possible to arrange the second control electrode segment 3-2 having a curved pattern right under the second electrode group 4 and to arrange the first and third control electrode segments 3-1 and 3-3 each having a curved pattern conforming with the pattern of the second control electrode segment 3-2 on both sides of the second control electrode segment 3-2, as shown in FIG. 4B. It is possible for these control electrode segments 3-1, 3-2, and 3-3 to be formed in a curved pattern or in a folded pattern.

### Third Embodiment

FIG. 5 is a cross sectional view schematically showing the construction of an electrophoretic display device according to a third embodiment of the present invention.

The display device shown in FIG. 5 is substantially equal in construction to the display device shown in FIG. 1. In the display device shown in FIG. 5, however, resistors 16-1 and 16-3 are connected in place of the capacitors 11-1 and 11-3 shown in FIG. 1 between the control electrode segments corresponding to regions having an electric field of a high intensity applied thereto, i.e., the first and third control electrode segments 3-1, 3-3, and the voltage source 10. It is possible for these resistors 16-1 and 16-3 to be of any of a linear type and a nonlinear type. In the construction shown in FIG. 5, an electric field having a high intensity is applied to each of the regions where the first and third control electrode segments 3-1 and 3-3 are arranged, with the result that the colored fine particles 6A are migrated with a high migration speed and the colored fine particles 6A within the pixel tend to be collected promptly to the particular regions noted above. Such being the situation, the voltage is applied to the first and third control electrode segments 3-1 and 3-3 through the resistors 16-1 and 16-3, respectively, in the case where voltage is applied to the first electrode group 3. It follows that the potential of each of the first and third control electrode segments 3-1 and 3-3 is moderately elevated to reach a prescribed potential a prescribed time later. As a result, if voltage is applied to the first electrode group 3, the potential of the second control electrode segment 3-2 is promptly elevated so as to cause the colored fine particles 6A within the pixel to be attracted to the control electrode segment 3-2. Then, the potential of each of the first and third control electrode segments 3-1 and 3-3 is elevated a prescribed time later, with the result that the colored fine particles 6A within the pixel are also attracted to the first and third control electrode segments 3-1 and 3-3. It should be noted that the intensity of the electric field is low in the region of each of the first and third control electrode segments 3-1 and 3-3 having the resistors 16-1 and 16-3 connected thereto as shown in FIG. 5. It follows that a time lag is generated in the change of the potential, and the migration of the colored fine particles is finally rendered substantially uniform over the entire region of the pixel.

The resistances of the resistors 16-1 and 16-3 are determined in accordance with the migration time period of the colored fine particles 6A. It is desirable to set the time constant τs within a range of between 1% and 1000% of the migration time period of the fine particles 6A. The time constant τs is determined by the capacitance that is provided between the first and third control electrode segments 3-1, 3-3 and the second electrode group 4 and the resistances of the resistors 16-1 and 16-3.

### Fourth Embodiment

FIG. 6 is a cross sectional view schematically showing the construction of an electrophoretic display device according to a fourth embodiment of the present invention.

The display device shown in FIG. 6 is substantially equal in construction to the display device shown in FIG. 5. In the display device shown in FIG. 6, however, switching elements 12-1, 12-2, and 12-3 are connected to the control electrode segments 3-1, 3-2, and 3-3, respectively. The potential rising time for each of the first and third control electrode segments 3-1 and 3-3 relative to the second control electrode segment 3-2 is controlled by the on-off control of the switching elements 12-1, 12-2 and 12-3, as in the display device according to the third embodiment of the present invention described above. As a result, the migration of the colored fine particles 6A within the pixel is rendered substantially uniform over the entire region of the pixel. The rising time can be controlled easily by allowing the switching timing of the switching element 12-2 connected to the second electrode segment 3-2 to be slightly deviated from that of each of the other switching elements 12-1 and 12-3.

Specific Examples 1 and 2 of the display device according to the fourth embodiment of the present invention will now be described. Needless to say, the technical scope of the present invention is not limited to the following Examples.

### EXAMPLE 1

A display device for Example 1 will now be described with reference to FIG. 1.

Used was an active matrix substrate 1 having a wiring and a thin film transistor (not shown) formed on a glass substrate. For allowing the source electrode of the thin film transistor included in each pixel to be electrically connected to the first electrode group 3, an ITO film was formed as the first electrode group 3 and patterned in the shape of a pixel electrode. In this case, in order to form the capacitors 11-1 and 11-3 between the first and third control electrode segments 3-1, 3-3 and the thin film transistor, an insulating film formed of SiOₓ was formed and patterned before formation of the ITO film in the portions where the source electrode of the thin film transistor was to be connected to the first and third control electrode segments 3-1, 3-3. The thickness of the SiOₓ film was determined to permit the voltage applied to the first and third control electrode segments 3-1 and 3-3 to fall within a range of between 60% and 90% of the voltage applied to the second control electrode segment 3-2.

In the next step, a partition wall 5 was formed to a height of 10 μm by using a photosensitive polyimide, followed by forming a nickel film on the surface of the partition wall 5 by applying a plating treatment to the partition wall 5 so as to form a second electrode group 4. Further, a dip coating with a transparent fluorine resin was applied so as to form an insulating film 15 in a thickness of 0.2 μm on the surface of the second electrode group 4.

An insulating liquid 6B having colored fine particles 6A dispersed therein for providing a dispersion liquid 6 was prepared as follows. Specifically, carbon black having a particle diameter of 1 μm was used as the electrophoretic fine particles 6A, and Isopar G manufactured by Exxon Mobile Inc. was used as the insulating liquid 6B. The electrophoretic fine particles 6A were dispersed in the insulating liquid 6B in an amount of 1% by weight based on the amount of the resultant dispersion liquid 6. Also, a trace of a surfactant was added to the dispersion liquid 6 for improving the stability of the dispersion liquid 6.

The substrate 1 was coated by the dip coating method with the resultant dispersion liquid 6 so as to load the dispersion liquid 6 in the pixel, followed by bonding a substrate 2 to the substrate 1 by the contact bonding so as to obtain a display device.

A white plate was arranged on the back surface of the substrate 1 for evaluating the optical characteristics. A DC voltage of 10V was applied between the first electrode group 3 and the second electrode group 4. As a result, the colored fine particles 6A were migrated from the second electrode group 4 to the first electrode group 3 so as to obtain a black display. In this case, the colored fine particles 6A were not collected in the region around the second electrode group 4 in which an electric field having a high intensity was applied, but were uniformly spread over the entire region of the pixel. Then, the polarity of the DC voltage was reversed so as to cause the colored fine particles 6A to be migrated toward the second electrode group 4. It was possible to obtain a good response even from the colored fine particles 6A that were present far away from the second electrode group 4. It was possible to obtain a white reflectance of 60%, a black reflectance of 6%, and a contrast of 10. Also, the response speed was found to be 100 milliseconds in terms of the response time.

### COMPARATIVE EXAMPLE 1

A structure comprising a first electrode group 3 of a single planar electrode was manufactured as a Comparative Example. The specific manufacturing method of the particular structure was equal to the method of manufacturing the display device for Example 1 and, thus, a detailed description is omitted in respect of the manufacturing method of the particular structure. In the display device for Comparative Example 1, the first electrode group 3 was formed of a single planar electrode. Therefore, when voltage was applied to the first electrode group 3, the same potential was imparted to the surface of the planar electrode.

A white plate was arranged on the back surface of the substrate 1 for evaluating the optical characteristics. Then, a DC voltage of 10V was applied between the first electrode group and the second electrode group. As a result, the colored fine particles 6A were migrated from the second electrode group 4 to the first electrode group 3 so as to obtain a black display. It should be noted that the colored fine particles 6A were collected in the region of the high electric field intensity around the second electrode group 4 so as to lower the concentration of the colored fine particles 6A in the central portion of the pixel. Such being the situation, the light rays were not absorbed by the colored fine particles 6A so as to leak to the outside of the apparatus. In order to permit the colored fine particles 6A to be migrated to reach the central region of the pixel, it was necessary to increase the applied voltage to 50V. Then, the polarity of the DC voltage was reversed so as to permit the colored fine particles 6A to be migrated toward the second electrode group 4. The response speed of the colored fine particles 6A present far away from the second electrode group 4 was low, and a long time was required for the colored fine particles 6A to be migrated to reach the second electrode group 4. The white reflectance obtained in this case was found to be 50%, the black reflectance obtained was found to be 15%, and the contrast was found to be 3. Also, the response speed was lowered such that the response time of 800 milliseconds was required for the change of the display from the black display to the white display.

### EXAMPLE 2

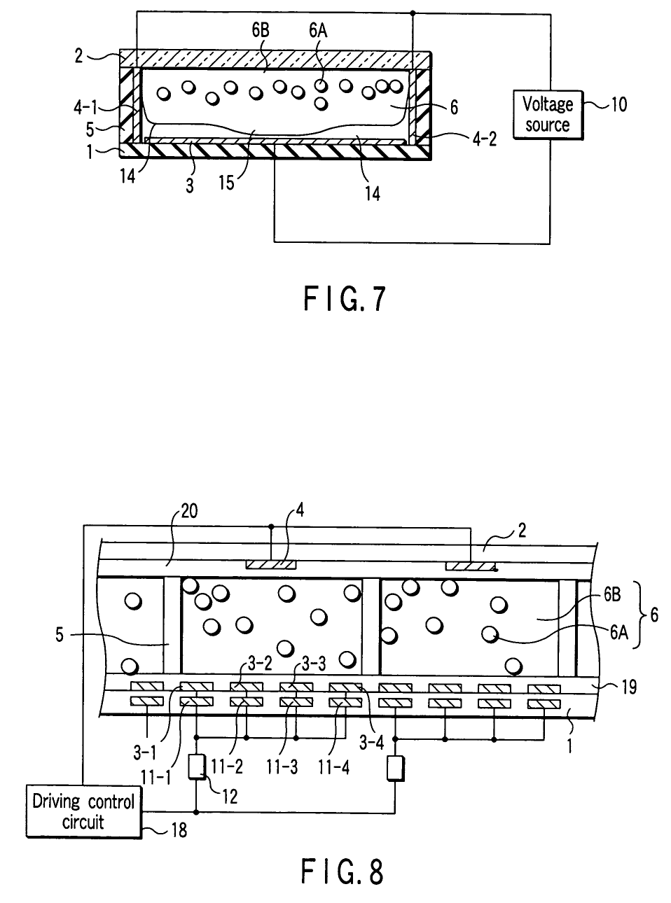

A display device for Example 2 will now be described with reference to FIG. 7.

For manufacturing the display device shown in FIG. 7, prepared was an active matrix substrate 1 having a wiring and a thin film transistor (not shown) formed on a glass substrate. For electrically connecting the source electrode of the thin film transistor included in the pixel to the first electrode group 3, an ITO film was formed as the first electrode group 3 and patterned in the shape of the pixel electrode.

In the next step, a partition wall 5 was formed in a height of 10 μm by using a photosensitive polyimide, followed by forming a nickel film on the surface of the partition wall 5 by applying a plating treatment to the partition wall 5 so as to form a second electrode group 4.

After formation of the second electrode group 4, a trace amount of a polyimide resin was dripped onto each pixel by an ink jet method, followed by drying and baking the polyimide resin so as to obtain an insulating film 15. In the process of drying and baking the insulating film 15, a meniscus 14 was formed by the effect of the surface tension in the vicinity of the partition wall 5, with the result that the insulating film 15 was rendered thicker in the vicinity of the partition wall 5 so as to substantially cover the second electrode group 4 formed on the partition wall 5. The thickness of the insulating film 15 was found to be 0.2 μm in the central portion of the pixel and 0.8 μm in the peripheral portion of the pixel. The surface of the substrate thus obtained was exposed to a plasma of a CF₄ gas for application of a water repelling treatment to the surface of the insulating film 15, followed by coating the substrate 1 by the dip coating method with the dispersion liquid 6 prepared in advance so as to load the dispersion liquid 6 in the pixel. Further, a substrate 2 was bonded to the substrate 1 by the contact bonding method so as to obtain a desired display device.

Incidentally, the second electrode group 4 was covered substantially completely with the insulating film 15 positioned on the partition wall 5 such that the insulating film 15 was rendered thicker in the vicinity of the partition wall 5, particularly, in the region where the first and second electrode groups 3 and 4 are positioned close to each other, and the thickness of the insulating film 15 was gradually decreased with increase in the distance of the second electrode group 4 from the first electrode group 3. As a result, the electrostatic capacitance in the peripheral portion of the pixel was rendered larger than that in the central portion of the pixel so as to realize substantially the structure that the capacitors 11-1 and 11-2 were incorporated in the peripheral portions of the pixel.

A white plate was arranged on the back surface of the substrate 1 for evaluating the optical characteristics. Then, a DC voltage of 10V was applied between the first electrode group 3 and the second electrode group 4. As a result, the colored fine particles 6A were migrated from the second electrode group 4 to the first electrode group 3 so as to obtain a black display. The colored fine particles 6A were not collected in the region of a strong electric field in the vicinity of the second electrode group 4, but were uniformly spread over the entire region of the pixel. Then, the polarity of the DC voltage was reversed so as to permit the colored fine particles 6A to be migrated toward the second electrode group 4. The response of the colored fine particles 6A positioned far away from the second electrode group 4 was found to be satisfactory. A voltage drop was brought about by the insulating film formed on the first electrode group 3. As a result, the intensity of the electric field within the pixel was rendered relatively low in the vicinity of the second electrode group 4 so as to achieve a uniform migration of the colored fine particles 6A. In this case, it was possible to obtain a white reflectance of 60%, a black reflectance of 4%, and a contrast of 15. Also, the response speed was found to be 100 milliseconds in terms of the response time. Since it was unnecessary to divide the pixel, the loss accompanying the aperture rate was eliminated completely so as to obtain a good image quality.

Incidentally, the insulating film 15 formed of the polyimide resin was rendered thinner in Example 2 in the central portion of the pixel. However, it is also possible to eliminate completely that portion of the insulating film 15 which is positioned in the central portion of the pixel. For example, it is possible to pattern the polyimide resin film so as to selectively remove the resin film from the central portion of the pixel. In this case, the insulating film 15 is not formed in the central region of the substrate 1, but is formed in the peripheral region alone of the substrate 1.

Example 2 can also be applied to the structure shown in FIG. 3. To be more specific, if the thickness of the insulating film 15 is increased in that region which is positioned on the central region of the first electrode group 3 corresponding to the region having a high electric field intensity, it is possible to realize the structure having the capacitor 11-2 substantially incorporated in the particular region. As a result, it is possible to obtain an effect similar to that produced from the structure shown in FIG. 3.

### Fifth Embodiment

FIG. 8 is a cross sectional view schematically showing the construction of the cell included in an electrophoretic display device according to a fifth embodiment of the present invention.

The electrophoretic display device shown in FIG. 8 comprises a dispersion liquid 6 including electrophoretic fine particles 6A having an electrically charged polarity as described previously and a transparent insulating liquid 6B having the electrophoretic fine particles 6A dispersed therein. The dispersion liquid 6 is loaded in a free space defined by a first substrate 1 on the side of the back surface, a transparent substrate 2 arranged to face the first substrate 1 on the side of the observer, and partition walls 5 arranged between the first substrate 1 and the second substrate 2 so as to support the first substrate 1 and the second substrate 2. In the electrophoretic display device shown in FIG. 8, the free space of the minimum unit, which is surrounded by the first substrate 1, the second substrate 2, and the partition walls 5 is called a pixel. A plurality of these pixels are arranged to form rows and columns in a planar direction so as to provide a planar display device.

A plurality of control electrode segments, e.g., first to fourth control electrode segments 3-1, 3-2, 3-3, and 3-4, which collectively constitute a first electrode group 3, are arranged within each pixel on the surface of the first substrate 1 on the side of the dispersion liquid 6. On the other hand, an opaque counter electrode segment 4 is formed as a second electrode group on the surface of the second substrate 2 on the side of the dispersion liquid 6. A dielectric layer 19 is formed on the surfaces of the control electrode segments 3-1, 3-2, 3-3 and 3-4. As a result, the control electrode segments 3-1, 3-2, 3-3 and 3-4 are prevented from being brought into a direct contact with the dispersion liquid 6. Also, a dielectric layer 20 is formed on the surface of the counter electrode segment 4 and, thus, the counter electrode segment 4 is also prevented from being brought into a direct contact with the dispersion liquid 6. The dielectric layer 20 is formed of a transparent material so as to make it possible to observe the inner state of the pixel from the side of the observer. Also, the dielectric layer 19 is formed of a transparent material or a white material. If the dielectric layer 19 is transparent, the first substrate 1 and the control electrode segments 3-1, 3-2, 3-3 and 3-4 are colored white.

The first to fourth control electrode segments 3-1, 3-2, 3-3 and 3-4 are connected to a switching element 12 via resistance layer films 11-1, 11-2, 11-3 and 11-4, respectively. The switching element 12 is connected to a driving circuit 18 such that the on-off operation of the switching element 12 is controlled by the driving circuit 18. The counter electrode segment 4 is also connected to the driving circuit 18 such that the voltage application to the counter electrode segment 4 is controlled by the driving circuit 18.

The electrophoretic display device according to the fifth embodiment of the present invention permits the pixels arranged in a two dimensional direction to display the intermediate color tone with a high stability.

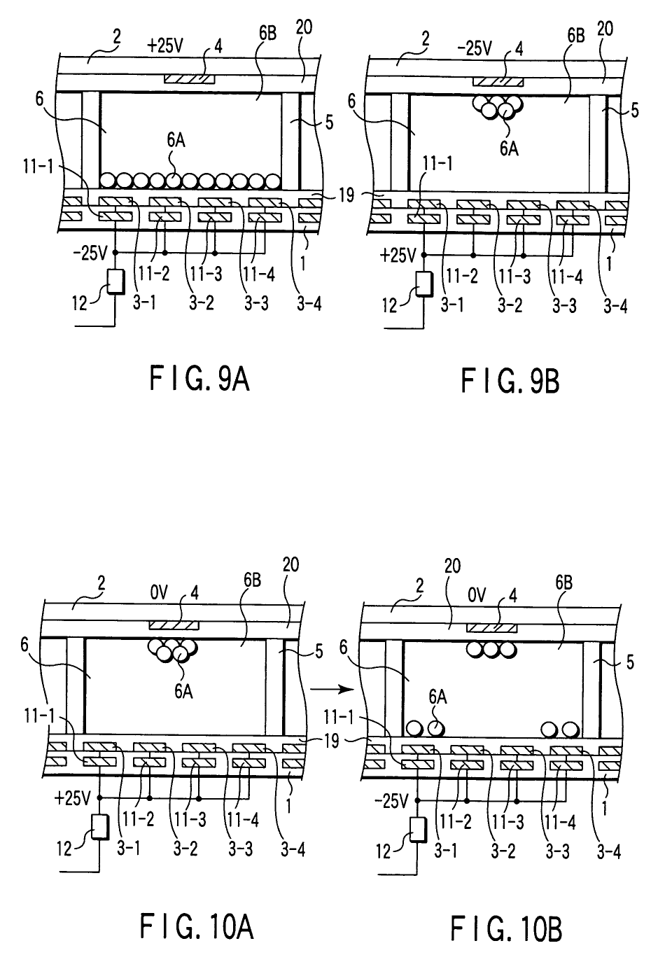

FIGS. 9A and 9B schematically show the method of allowing each pixel included in the electrophoretic display device constructed as shown in FIG. 8 to display binary values of black and white, and FIGS. 10A and 10B schematically show the method of allowing each pixel included in the electrophoretic display device constructed as shown in FIG. 8 to display an intermediate color tone. In the embodiment shown in the drawings, the electrophoretic fine particles are colored black and charged positive. Also, the insulating liquid 6B is formed of a colorless transparent liquid. Further, the dielectric layer 19 is formed transparent or is colored white. Still further, the first to fourth control electrode segments 3-1, 3-2, 3-3 and 3-4 are connected to the switching element 12 via the resistance layer films 11-1, 11-2, 11-3, and 11-4, respectively.

Where the pixel shown in FIG. 8 is made to display the black color, which is the color of the electrophoretic fine particles 6A, the positively charged electrophoretic fine particles 6A are migrated to the first substrate 1. The black fine particles 6A arranged on the dielectric layer 9 are observed from the side of the observer through the transparent second substrate 2, the dielectric layer 10 and the insulating liquid 6B and, thus, the pixel is recognized as being black.

In order to bring about the migration of the electrophoretic fine particles 6A as described above, a negative potential of −25V is applied to the first to fourth control electrode segments 3-1, 3-2, 3-3 and 3-4, and a positive potential of +25V is applied to the counter electrode segment 4, as shown in FIG. 9A. By the application of the potential to the control electrode segments 3-1, 3-2, 3-3, 3-4 and to the counter electrode segment 4 as pointed out above, the positively charged electrophoretic fine particles 6A are attracted to the first to fourth control electrode segments 3-1, 3-2, 3-3 and 3-4, which are maintained at a negative potential, so as to be arranged on the dielectric layer 19 positioned to cover the first to fourth control electrode segments 3-1, 3-2, 3-3 and 3-4.

When the white color is displayed by the pixel, the positively charged electrophoretic fine particles 6A are migrated toward the second substrate 2 on the side of the observer so as to be collected on the dielectric layer 20 covering the counter electrode segment 4. Since the counter electrode segment 4 is opaque, the black fine particles 6A collected behind the counter electrode segment 4 are shielded by the counter electrode segment 4 from the side of the observer, with the result that the black fine particles 6A are substantially caused to cease to be observed. It follows that the color of the first substrate 1 or the color of the dielectric body 19 formed on the first substrate 1 is observed.

As described above, where the white color is displayed, a positive potential of +25V is applied to the first to fourth control electrode segments 3-1, 3-2, 3-3 and 3-4, and a negative potential of −25V is applied to the counter electrode segment 4, as shown in FIG. 9B. In this stage, the values of the first to fourth control electrode segments 3-1, 3-2, 3-3 and 3-4 denote the values on the output side of the switching element 12. The first to fourth control electrode segments 3-1, 3-2, 3-3 and 3-4 arrive at the output voltage generated from the switching element a prescribed time later, i.e., after the lapse of time determined in accordance with the time constant τ1, which is determined by the resistances of the resistor layer films 11-1, 11-2, 11-3 and 11-3 connected to the first to fourth control electrode segments 3-1, 3-2, 3-3 and 3-4, respectively, and the electrostatic capacitance that is present between the first electrode and the second electrode or the stray capacitance. As already described, the time constants τ1, τ2, τ3, and τ4, between each of the first to fourth control electrode segments 3-1, 3-2, 3-3, 3-4 and the counter electrode segment 4 differ from each other. It follows that the time required for saturating the voltage value of each of the first to fourth control electrode segments 3-1, 3-2, 3-3 and 3-4 differs from each other. The electrophoretic fine particles 6A are migrated moderately under an electric field having a large time constant, and are migrated promptly under an electric field having a small time constant. In the display device shown in FIG. 8, the time constant τ2 between the second and third control electrode segments 3-2 and 3-3, which are arranged right under the counter electrode segment 4 and have a short distance from the counter electrode segment 4, is set at a large value. On the other hand, the time constant τ1 between the counter electrode segment 4 and each of the first and fourth control electrode segments 3-1 and 3-4, which have a relatively large distance from the counter electrode segment 4, is set at a small value. It follows that the electrophoretic fine particles 6A are moderately migrated from the second and third counter electrode segments 3-2 and 3-3 toward the counter electrode segment 4, and are promptly migrated at a high response speed from the first and fourth control electrode segments 3-1 and 3-4 toward the counter electrode segment 4. The resistances of the resistor layer films 11-2 and 11-3 connected to the second and third control electrode segments 3-2 and 3-3 are set larger than those of the resistor layer films 11-1 and 11-4 connected to the first and fourth control electrode segments 3-1 and 3-4 so as to impart the large time constant τ2 as described above.

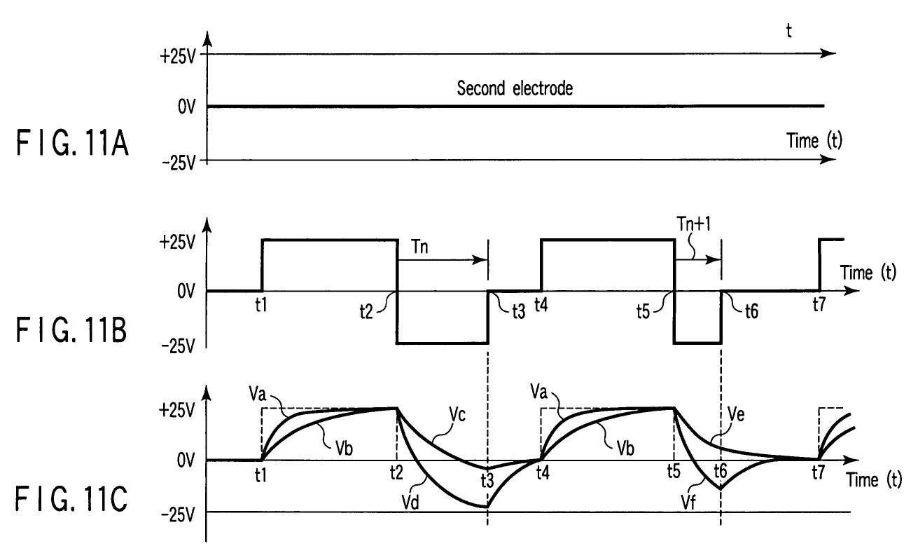

The operation for displaying an intermediate color tone will now be described with reference to FIGS. 10A, 10B, 11A, 11B and 11C.

As shown in FIG. 10A, a positive potential of +25V is applied first to each of the first to fourth control electrode segments 3-1, 3-2, 3-3 and 3-4 in order to collect the electrophoretic fine particles on the counter electrode segment 4. As a result, the electrophoretic fine particles 6A begin to be migrated from the first to fourth control electrode segments 3-1, 3-2, 3-3 and 3-4 toward the counter electrode segment 4. Then, a negative potential of −25V is outputted from the switching element 12 on the output side with the counter electrode segment 4 maintained at zero potential of 0V, as shown in FIG. 10B. The level of the intermediate color tone that is to be displayed is controlled by controlling the period during which the negative potential of −25V is kept outputted from the switching element 12 on the output side.

In the operation for displaying the intermediate color tone, the potential or voltage shown in FIGS. 11A to 11C is imparted to each of the electrode segments so as to display the intermediate color tone. It should be noted that FIG. 11A shows the potential of the counter electrode segment 4, FIG. 11B shows the change in the voltage signal outputted from the switching element 12, and FIG. 11C shows the changes V1 and V2 in the potentials at the first and second control electrode segments 3-1 and 3-2. FIGS. 11A to 11C show the display operation of the intermediate color tone covering two periods. As described previously, the time constant τ2 of the electric circuit is set at a large value for the second and third control electrode segments 3-2 and 3-3, and the time constant τ1 is set at a small value for the first and fourth control electrode segments 3-1 and 3-4.

As shown in FIG. 11A, the counter electrode segment 4 is maintained constant at 0V entire over the first and second periods. In the first period, the switching element 12 is turned on at time t1 as shown in FIG. 11B. As a result, a positive voltage of +25V is applied from the driving control circuit 18 to the first to fourth control electrode segments 3-1, 3-2, 3-3 and 3-4 through the switching element 12 and the resistor layer films 11-1, 11-2, 11-3 and 11-4, respectively. Then, at time t2, the switching element 12 is switched so as to reverse the voltage signal supplied from the driving control circuit 18 from the positive voltage of +25V to a negative voltage of −25V. As a result, the negative voltage of −25V is applied from the driving control circuit 18 to the first to fourth control electrode segments 3-1, 3-2, 3-3 and 3-4 through the switching element 12 and the resistor layer films 11-1, 11-2, 11-3 and 11-4, respectively. In the first period, the negative voltage of −25V is kept applied for a certain time period Tn, and at time t3, the switching element 12 is switched so as to permit the first to fourth control electrode segments 3-1, 3-2, 3-3 and 3-4 to be connected to zero voltages. During the time period between time t1 and time t2, the potentials of the first to fourth control electrode segments 3-1, 3-2, 3-3 and 3-4 are gradually elevated so as to reach a positive potential of +25V at time t2, as shown in FIG. 1C. It should be noted in this connection that the time constant τ2 for each of the second and third control electrode segments 3-2 and 3-3 is set larger than the time constant τ1 for each of the first and fourth control electrode segments 3-1 and 3-4, as described previously. It follows that the potential of each of the first and fourth control electrode segments 3-1 and 3-4 is elevated rapidly as denoted by a curve Va. On the other hand, the potential of each of the second and third control electrode segments 3-2 and 3-3 is elevated moderately as denoted by a curve Vb.

In accordance with elevation of the potential for each of the first to fourth control electrode segments 3-1, 3-2, 3-3 and 3-4, the electrophoretic fine particles 6A are migrated from the first to fourth control electrode segments 3-1, 3-2, 3-3 and 3-4 toward the counter electrode segment 4, as shown in FIG. 10A. Since the potential of each of the first and fourth control electrode segments 3-1 and 3-4, which are positioned in the peripheral portion of the pixel, is changed relatively rapidly, the electrophoretic fine particles 6A are migrated from the first and fourth control electrode segments 3-1 and 3-4 toward the counter electrode segment 4 with a high response speed. On the other hand, the potential of each of the second and third control electrode segments 3-2 and 3-3, which are positioned in the central portion of the pixel, is changed relatively moderately. As a result, the electrophoretic fine particles 6A are migrated from the second and third control electrode segments 3-2 and 3-3 toward the counter electrode segment 4 relatively moderately.

In the time period Tn between time t2 and time t3, which is shorter than the time period between time t1 and time t2, the potential for each of the first and fourth control electrode segments 3-1 and 3-4 is rapidly lowered to −25V as denoted by a curve Vd because the time constant τ1 for each of the first and fourth control electrode segments 3-1 and 3-4, which are positioned in the peripheral portion of the pixel, is relatively small. On the other hand, the potential for each of the second and third control electrode segments 3-2 and 3-3 is moderately lowered as denoted by a curve Vc because the time constant τ1 for each of the second and third control electrode segments 3-2 and 3-3, Which are positioned in the central portion of the pixel, is relatively large. In this case, the potential for each of the second and third control electrode segments 3-2 and 3-3 fails to be lowered to reach a negative potential of −25V, though the potential is certainly lowered to reach a negative potential. Such being the situation, the electrophoretic fine particles 6A are rapidly migrated from the counter electrode segment 4 toward the first and fourth control electrode segments 3-1 and 3-4, which are positioned in the peripheral portion of the pixel. On the other hand, the electrophoretic fine particles 6A, which are to be migrated from the counter electrode segment 4 toward the second and third control electrode segments 3-2 and 3-3, which are positioned in the central portion of the pixel, are retained on the counter electrode segment 4 so as to be dispersed in the insulating liquid 6B. It follows that, if the pixel is observed, it is recognized that the electrophoretic fine particles 6A are attracted toward the first and fourth control electrode segments 3-1 and 3-4 and are dispersed in the pixel. As a result, a certain intermediate color tone is displayed during the time period Tn. Also, during the time period between time t3 and time t4, zero volts is applied to each of the first to fourth control electrode segments 3-1, 3-2, 3-3 and 3-4, with the result that the potential of each of the first and fourth control electrode segments 3-1 and 3-4 is rapidly brought back to zero volts, and the potential of each of the second and third control electrode segments 3-2 and 3-3 is moderately brought back to zero volts. Such being the situation, the electrophoretic fine particles 6A are kept dispersed in the insulating liquid 6B, and the electrophoretic fine particles 6A attracted by the first and fourth control electrode segments 3-1 and 3-4 are dispersed in the insulating liquid 6B. As a result, the intermediate color tone is kept displayed in also the time period between time t3 and time t4.

In also the second period starting with time t4, the switching element 12 is turned on first so as to apply a positive voltage of +25V from the driving control circuit 18 to the first to fourth control electrode segments 3-1, 3-2, 3-3 and 3-4, as shown in FIG. 11B. Then, the switching element 12 is switched so as to reverse the voltage signal supplied from the driving control circuit 18 from the positive voltage of +25V to a negative voltage of −25V, with the result that the negative voltage of −25V is applied from the driving control circuit 18 to each of the first to fourth control electrode segments 3-1, 3-2, 3-3 and 3-4. During the second period, the negative voltage of −25V is kept applied during the time period Tn+1, which is shorter than the time period Tn in the first period. Then, the switching element 12 is switched at time t6 so as to permit the first to fourth control electrode segments 3-1, 3-2, 3-3 and 3-4 to be connected to zero volts. During the time period between time t4 and time t5, the potential of each of the first and fourth control electrode segments 3-1 and 3-4 is rapidly elevated as denoted by a curve Va shown in FIG. 1C. The particular situation is equal to that which is observed during the time period between time t1 and time t2. On the other hand, the potential for each of the second and third control electrode segments 3-2 and 3-3 is moderately elevated, as denoted by a curve Vb.

It should be noted that, since the potential is changed relatively rapidly in each of the first and fourth control electrode segments 3-1 and 3-4, which are positioned in the peripheral portion of the pixel, the electrophoretic fine particles 6A are migrated from the first and fourth control electrode segments 3-1 and 3-4 toward the counter electrode segment 4 with a high response speed. Also, since the potential is changed relatively moderately in each of the second and third control electrode segments 3-2 and 3-3, which are positioned in the central portion of the pixel, the electrophoretic fine particles 6A are migrated relatively moderately from the second and third control electrode segments 3-2 and 3-3 toward the counter electrode segment 4.

During the time period Tn+1 between time t5 and time t6, which is shorter than the time period between time t4 and time t5, the potential of each of the first and fourth control electrode segments 3-1 and 3-4, which are positioned in the peripheral portion of the pixel, is rapidly lowered toward a negative potential of −25V as denoted by a curve Ve because the time constant τ1 for each of these first and fourth control electrode segments 3-1 and 3-4 is relatively small. On the other hand, the time constant τ2 for each of the second and third control electrode segments 3-2 and 3-3, which are positioned in the central portion of the pixel, is relatively large. It follows that the potential for each of the second and third control electrode segments 3-2 and 3-3 is moderately lowered, as denoted by a curve Vf. During the second period, the time period between time t4 and time t5 is equal to the time period between time t1 and time t2 included in the first period. It follows that the electrophoretic fine particles 6A are migrated as in the first period. On the other hand, the time period Tn+1 included in the second period is shorter than the time period Tn included in the second period. It follows that the potential for each of the first and fourth control electrode segments 3-1 and 3-4 is not lowered to reach a negative potential of −25V, though the potential is certainly lowered to reach a negative potential. Also, the potential for each of the second and third control electrode segments 3-2 and 3-3, which are positioned in the central portion of the pixel, is not lowered to reach even a negative potential, though the potential is lowered to a low level of the positive potential. Such being the situation, the electrophoretic fine particles 6A are rapidly migrated from the counter electrode segment 4 to the first and fourth control electrode segments 3-1 and 3-4, which are positioned in the peripheral portion of the pixel. However, the electrophoretic fine particles 6A are not migrated to reach the first and fourth control electrode segments 3-1 and 3-4, and are dispersed in the insulating liquid 6B. Also, the electrophoretic fine particles 6A that are to be migrated from the counter electrode segment 4 toward the second and third control electrode segments 3-2 and 3-3, which are positioned in the central portion of the pixel, are allowed to stay on the counter electrode segment 4. It follows that, if the pixel is observed, the state that the electrophoretic fine particles 6A are dispersed in a part of the pixel is recognized, with the result that an intermediate color toner brighter than that of the intermediate color tone displayed during the time period Tn included in the first period is displayed during the time period Tn+1.

Also, during the time period between time t6 and time t7, zero volts is applied to each of the first to fourth control electrode segments 3-1, 3-2, 3-3 and 3-4. As a result, the potential of each of the first and fourth control electrode segments 3-1 and 3-4 is rapidly brought back to zero volts, and the potential of each of the second and third control electrode segments 3-2 and 3-3 is moderately brought back to zero volts. It follows that the electrophoretic fine particles 6B dispersed in the insulating liquid 6B are kept dispersed in the insulating liquid 6B, and the electrophoretic fine particles 6A attracted toward the counter electrode segment 4 are dispersed in the insulating liquid 6B. Such being the situation, a brighter display of the intermediate color tone is maintained even during the time period between time t6 and time t7.

As described above, it is possible to control the electrophoresis of the electrophoretic fine particles 6A by controlling the time period Tn and the time period Tn+1 by switching the switching element 12. What should be noted is that it is possible to display the intermediate color of various tones with a high stability in accordance with the control of the electrophoresis.

A specific Example of the electrophoretic display device according to the present invention will now be described.

### EXAMPLE 3

The electrophoretic display device constructed as shown in FIG. 8 was manufactured as follows. Specifically, each of the first substrate 1 and the second substrate 2 was formed of a transparent glass plate having a thickness of 0.7 mm. The distance between the first substrate 1 and the second substrate 2 was set at about 80 μm, and the distance between the adjacent partition walls 5 was set at about 80 μm.

The first to fourth control electrode segments 3-1, 3-2, 3-3, 3-4, the switching element 12, and the resistance layer films 11-1, 11-2, 11-3, 11-4 were formed on the first substrate 1 by the known TFT manufacturing process together with the driving circuit. The dielectric layers 19 and 20 were formed in order to prevent the electrophoretic fine particles 6A from being unavoidably adsorbed on the first to fourth control electrode segments 3-1, 3-2, 3-3, 3-4 and on the counter electrode segment 4. Each of the dielectric layers 19 and 20 was formed in a thickness of 0.5 μm by the dip coating method using a transparent fluorine resin. Further, the partition wall 5 was formed by forming a polyimide film acting as an insulating layer in a thickness of 80 μm on the second substrate 2, followed by selectively etching the polyimide film.

The dispersion liquid was prepared as follows. Specifically, a black resin toner having a particle diameter of 1 μm and prepared by coating a carbon powder with polyethylene was used as the electrophoretic fine particles 6A. On the other hand, isopropanol was used as the insulating liquid 6B. The dispersion liquid 6 was prepared by adding 10% by weight of the electrophoretic fine particles 6A to the insulating liquid 6B together with a trace amount of a surfactant, to improve the dispersion stability. In this case, the surfaces of the electrophoretic fine particles 6A were charged positive. After the first substrate 1 and the second substrate 2 were aligned and bonded to each other, the dispersion liquid was poured into the pixel defined between the first substrate 1 and the second substrate 2 so as to finish manufacture of the display device.

### Sixth Embodiment

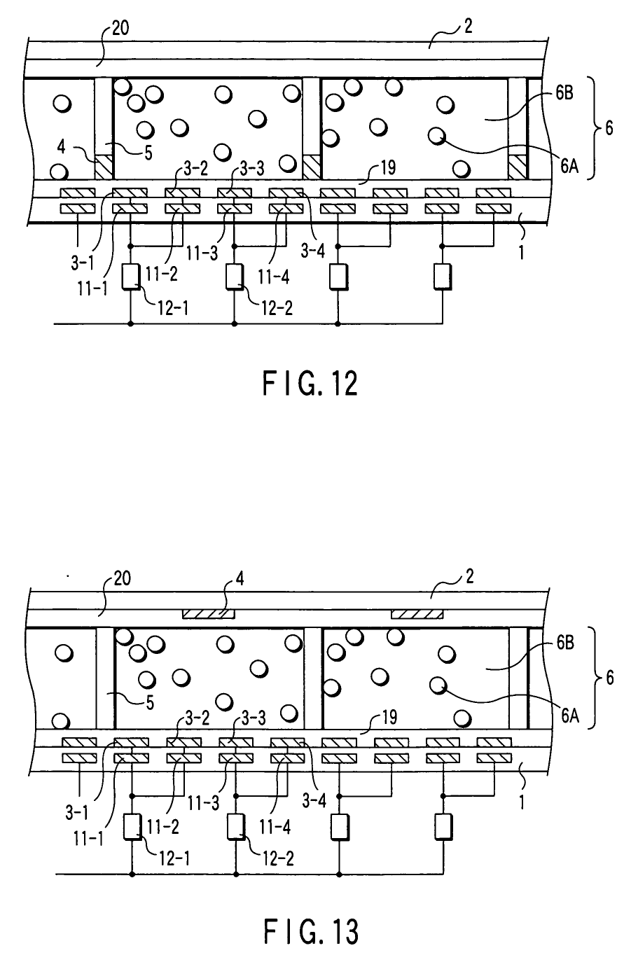

In the display device shown in FIG. 8, which is capable of displaying the intermediate color tone, the counter electrode segment 4 was mounted to the second substrate 2. However, it is also possible to mount the counter electrode segment 4 to the partition wall 5 serving to partition the pixel, as shown in FIGS. 1 and 12. In this construction, both the first electrode segments and the counter electrode segments can be mounted to the first substrate 1. As a result, it is possible to achieve a cost reduction. In addition, various materials can be used for forming the second substrate 2.

### Seventh Embodiment

In the display device shown in FIG. 8, which is capable of displaying the intermediate color tone, a single switching element 12 is connected to each pixel. However, it is also possible for a plurality of switching elements 12-1 and 12-2 to be connected to each pixel, as shown in FIG. 12 or FIG. 13. By mounting a plurality of switching elements 12-1 and 12-2, the display of the intermediate color tone can be controlled more finely.

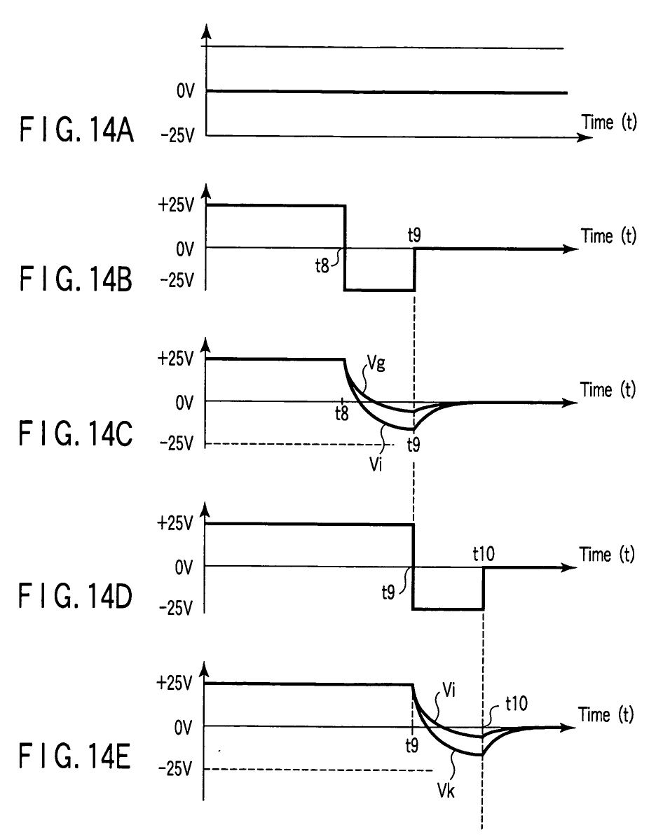

In the electrophoretic display device shown in FIG. 12 or FIG. 13, in which the first switching element 12-1 is connected to the first and second control electrode segments 3-1 and 3-2, and the second switching element 12-2 is connected to the third and fourth control electrode segments 3-3 and 3-4, the first and second switching elements 12-1 and 12-2 are controlled as shown in FIGS. 14A, 14B, 14C, 14D and 14E. To be more specific, under the state that the counter electrode segment 4 is maintained at zero volts as shown in FIG. 14A and a positive voltage of +25V is applied to the first to fourth control electrode segments 3-1, 3-2, 3-3 and 3-4 through the first and second switching elements 12-1 and 12-2 as shown in FIGS. 14B and 14D, the first switching element 12-1 is turned on first at time t8 shown in FIG. 14B so as to permit the negative electrode of −25V to be applied to the first and second control electrode segments 3-1 and 3-2 through the first switching element 12-1. It follows that the potential of each of the first and second control electrode segments 3-1 and 3-2 is lowered to a negative potential, as denoted by curves Vg and Vi shown in FIG. 14C. It should be noted that the time constant τ1 imparted to the first control electrode segment 3-1 is set smaller than the time constant τ2 imparted to the second control electrode segment 3-2. It follows that the potential of the first control electrode segment 3-1 is lowered more rapidly than the potential of the second control electrode segment 3-2. At time t9 shown in FIG. 14B, the first switching element 12-1 is turned off so as to permit zero volts to be applied to the first and second control electrode segments 3-1 and 3-2 through the first switching element 12-1. At the same time, the second switching element 12-2 is turned on as shown in FIG. 14D so as to permit a negative voltage of −25V to be applied to the third and fourth control electrode segments 3-3 and 3-4 through the second switching element 12-2. It follows that the potential of each of the first and second control electrode segments 3-1 and 3-2 is brought back to zero volts as denoted by curves Vg and Vi shown in FIG. 14C. On the other hand, the voltage of each of the third and fourth control electrode segments 3-3 and 3-4 is lowered to a negative potential as denoted by curves Vj and Vk in FIG. 14E. It should be noted that the time constant τ3 imparted to the third control electrode segment 3-3 is set smaller than the time constant τ4 imparted to the fourth control electrode segment 3-4. As a result, the potential of the third control electrode segment 3-3 is lowered more rapidly than the potential of the fourth control electrode segment 3-4. Then, at time t10 shown in FIG. 14D, the second switching element 12-2 is turned off so as to permit zero potential to be applied to the third and fourth control electrode segments 3-3 and 3-4 through the second switching elements 12-2, with the result that the potential of each of the third and fourth control electrode segments 3-3 and 3-4 is brought back to zero potential as denoted by the curves Vj and Vk shown in FIG. 14E.

According to the driving of the first to fourth control electrode segments 3-1, 3-2, 3-3 and 3-4 shown in FIGS. 14A to 14E, the potential of the first control electrode segment 3-1 is lowered first to a negative potential and, then, the potential of the second control electrode segment 3-2 is lowered to a negative potential. Then, after time t9, the potential of the third control electrode segment 3-3 is lowered first to a negative potential and, then, the potential of the fourth control electrode segment 3-4 is lowered to a negative potential. In other words, the potential is lowered in the order of the first to fourth control electrode segments 3-1, 3-2, 3-3 and 3-4 so as to attract the electrophoretic fine particles 6A in the order mentioned. In this fashion, it is possible to control the electrophoretic fine particles 6A for each of the first to fourth control electrode segments 3-1, 3-2, 3-3 and 3-4 and, thus, it is possible to make uniform the number of electrophoretic fine particles 6A collected on each segment of the control electrode.

### Eighth Embodiment

In order to display the black color uniformly within the pixel, it is necessary to carry promptly out the operation to collect the electrophoretic fine particles on the counter electrode segment 4, i.e., the initialization for displaying the intermediate color tone, as described previously in conjunction with FIGS. 10A and 10B. The uniformity in the concentration of the electrophoretic fine particles for the black display can be improved by this prompt initialization. For realizing the black display, required is a circuit that can actively change the time constant τ.

As described previously in conjunction with FIG. 11, the initialization in the stage of displaying the intermediate color tone, i.e., the operation to collect the electrophoretic fine particles on the second electrode (counter electrode), is dependent on the time constant τ that is determined by, for example, the resistance element, and the time required for the initialization is determined by the largest time constant τ. The time for the initialization is substantially equal to the writing time for the display of the intermediate color tone. It follows that, in the display in which the writing time is required to be shortened, it is necessary to decrease the proportion of the initialization time relative to the time for displaying the intermediate color tone.

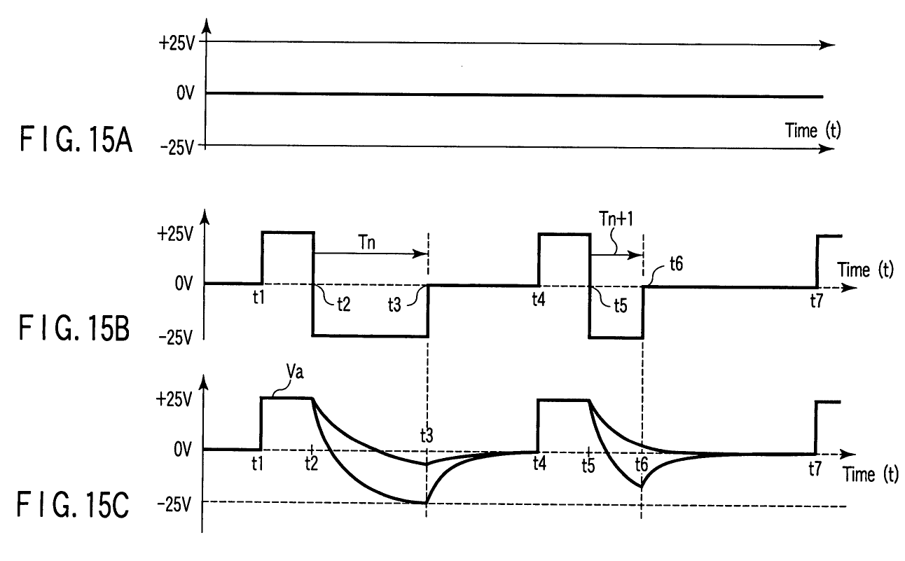

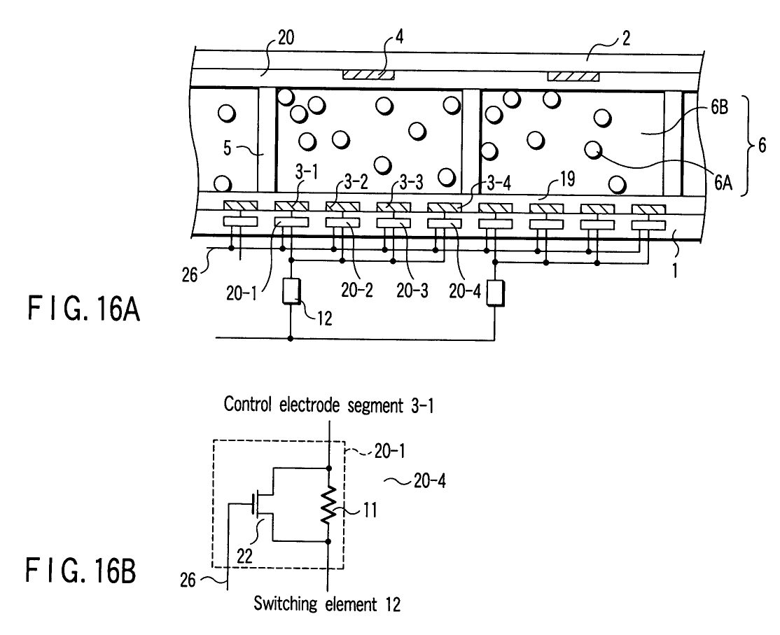

FIGS. 15A, 15B and 15C show the waveforms of the potential and the voltage corresponding to the waveforms shown in FIGS. 11A, 11B and 11C, respectively. FIG. 16A is a cross sectional view schematically showing the construction of the display device to which the potential and voltage having the waveforms shown in FIGS. 15A to 15C are applied. Further, FIG. 16B shows the circuit construction of each of resistance circuit elements 20-1 to 20-4 shown in FIG. 16A. The reference numerals in FIGS. 11A to 11C and FIG. 8 are used in FIGS. 15A to 15C and FIG. 16A so as to omit the detailed description of FIGS. 15A to 15C and FIG. 16A.

FIG. 15A shows the potential of the counter electrode segment 4. FIG. 15B shows the change in the voltage signal generated from the switching element 12. Further, FIG. 15C shows changes V1 and V2 in the potentials of the first and second control electrode segments 3-1 and 3-2. As apparent from the drawings, FIGS. 15A to 15C show the display operation of the intermediate color tone covering two periods.

The initializing period between time t1 and time t2 shown in FIG. 15B, during which a positive voltage of +25V is applied to the first to fourth control segments 3-1, 3-2, 3-3 and 3-4, is set shorter than the initializing period shown in FIG. 11B. In addition, as apparent from the comparison with FIG. 1C, the potential of each of the first to fourth control electrode segments 3-1, 3-2, 3-3 and 3-4 is rapidly elevated to the positive potential of +25V during the initializing period between time t1 and time t2. In other words, during the initializing period between time t1 and time t2, the time constant τ is substantially zero and, thus, the potential of each of the first to fourth control electrode segments 3-1, 3-2, 3-3 and 3-4 is elevated in response to the application of the positive voltage of +25V. After the initialization, the potential of each of the first to fourth control electrode segments 3-1, 3-2, 3-3 and 3-4 is gradually lowered and, then, gradually brought back to zero under the influence of the time constant τ as apparent from the situation during the time period between time t2 and time t4. Since the potential of each of the first to fourth control electrode segments 3-1, 3-2, 3-3 and 3-4 is rapidly elevated during the initializing period as pointed out above, it is possible to promptly collect the electrophoretic fine particles on the second electrode (counter electrode) segment 4 so as to make it possible to shorten the initializing period.

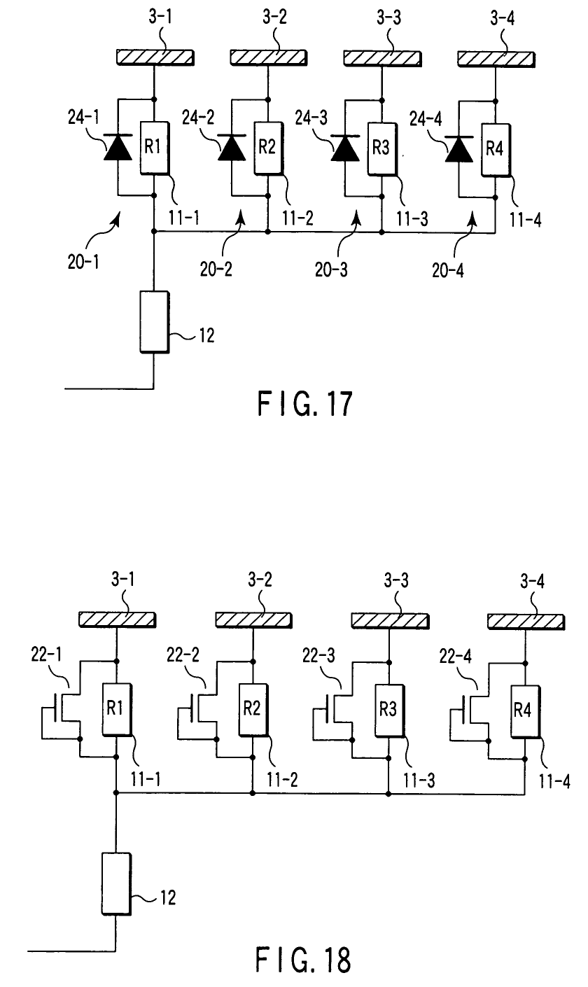

For realizing the initialization as described above, resistance circuit elements 20-1 to 20-4 are incorporated in place of the resistor layer films 11-1 to 11-4 in the substrate 1, as shown in FIGS. 16A and 17. As apparent from FIGS. 16B and 17, each of the resistance circuit elements 20-1 to 20-4 comprises a TFT 22 or a diode 24 connected in parallel to the resistor layer film 11. During application of the positive voltage of +25V, the TFT 22 or the diode 24 is turned on so as to form a short circuit avoiding the resistor layer film 11. In this stage, the time constant is set substantially at zero.

If the output of each of the switching elements 12-1 and 12-2 has a positive voltage of +25V in any of the resistance circuit elements 20-1 to 20-4 of the construction described above, the current flows through the diodes 24-1 to 24-4 so as to rapidly elevate the potential of each of the first to fourth control electrode segments 3-1, 3-2, 3-3 and 3-4 to a positive voltage of +25V, as shown in FIG. 17. If the output of each of the switching elements 12-1 and 12-2 has a negative voltage of −25V or a zero potential during the period between time t2 and time t3 or during the period between time t3 and time t4, the diode 22 is turned off, and the voltage is applied to each of the first to fourth control electrode segments 3-1, 3-2, 3-3 and 3-4 through the resistance layer films 11-1 to 11-4 having the resistance R1 to R4, respectively. It follows that the potential of each of the first to fourth control electrode segments 3-1, 3-2, 3-3 and 3-4 is lowered and, then, brought back to zero potential successively with the delay time determined in accordance with the time constant τ, wherein the time constant τ is determined by the resistance R1 to R4, as described previously in conjunction with FIGS. 10A and 10B. Also, according to the circuit shown in FIGS. 16A and 17, the potential of each of the first to fourth control electrode segments 3-1, 3-2, 3-3 and 3-4 is rapidly changed in the stage of displaying a black color on the pixel. It follows that the black particles can be displayed uniformly within the pixel.

### Ninth Embodiment

In the circuit shown in FIG. 16A, a signal line 26 for applying a gate signal to the gate electrode of the TFT 22 in synchronism with the application of the positive voltage of +25V is connected separately to the gate of the TFT 22. However, for simplifying the circuit, it is possible for the gate of each of the N-channel TFTs 22-1 to 22-4 to be connected to the source of the TFT, as shown in FIG. 18. In the circuit shown in FIG. 18, each of the TFTs 22-1 to 22-4 is of a diode structure that is constructed such that the TFTs 22-1 to 22-4 are rendered conductive upon application of a positive voltage of +25V from the switching element 12. Where the output of the switching element 12 is negative, the TFTs 22-1 to 22-4 are kept turned off and, thus, current does not flow through these TFTs. Also, voltage is applied to the first to fourth control electrode segments 3-1, 3-2, 3-3 and 3-4 through the resistance layer films 11-1 to 11-4. In the circuit construction described above, the TFTs 22-1 to 22-4 having the specification equal to that of the switching element 12 can be used as diodes. Also, it is possible for the resistor layer films 11-1 to 11-4 not to be particularly connected to the circuit, and it is possible to use equivalently the off-resistance of the TFTs 22-1 to 22-4 as the resistor layer films 11-1 to 11-4. In this fashion, in the circuit construction shown in FIG. 18, the circuit can be substantially simplified in view of the manufacturing process.

### Tenth Embodiment

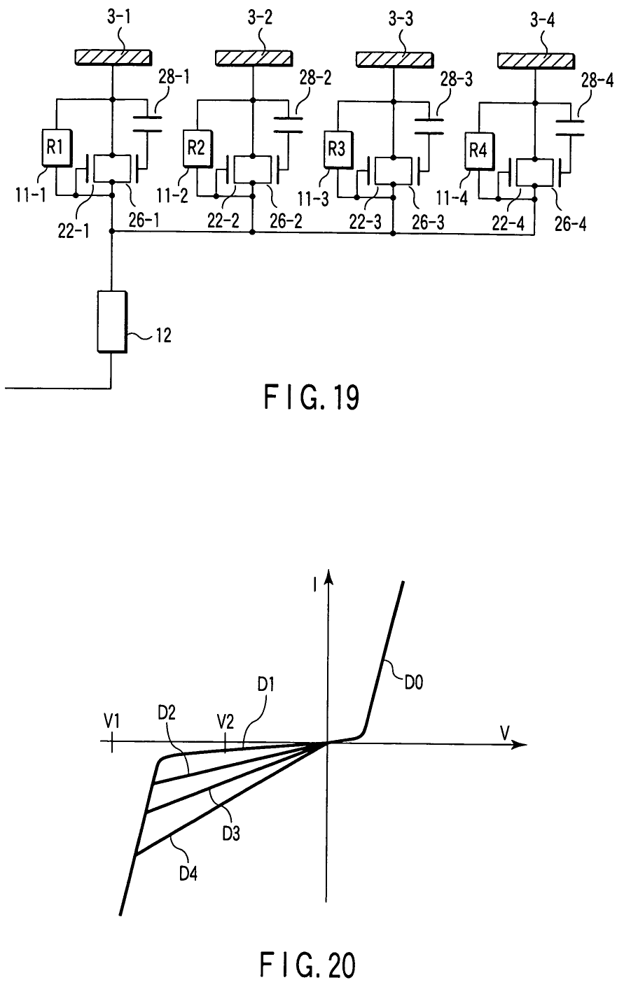

A display device according to a tenth embodiment of the present invention, which permits uniformly displaying the black color within the pixel, will now be described with reference to FIGS. 19 and 20.

Where the black color is displayed by elongating the ON time of the switching element 12 by the driving method shown in FIG. 11, it is possible for the concentration of the electrophoretic fine particles 6A to be rendered non-uniform within the pixel. For overcoming the difficulty relating to the black color display noted above, it is desirable for the circuit to be constructed as shown in FIG. 19. In the circuit shown in FIG. 19, the first to fourth control electrode segments 3-1, 3-2, 3-3 and 3-4 can be made to instantaneously bear the same potential.

As shown in FIG. 19, a rectifying element formed of TFTs 22-1 to 22-4 and resistor layer films 11-1 to 11-4 are arranged in parallel between the switching element 12 and the first to fourth control electrode segments 3-1, 3-2, 3-3 and 3-4. Concerning the current-voltage characteristics of the parallel circuit noted above, the ordinary diode characteristics D0 can be obtained if the output voltage of the switching element 12 is positive, as shown in FIG. 20. In the circuit shown in FIG. 19, TFTs 26-1 to 26-4 and capacitors 28-1 to 28-4 are connected in parallel between the switching element 12 and the first to fourth control electrode segments 3-1, 3-2, 3-3 and 3-4. It follows that, if the output voltage of the switching element 12 is negative, the TFTs 26-1 to 26-4 are not instantly turned on because of the presence of the capacitors 28-1 to 28-4 connected between the gates of the TFTs 26-1 to 26-4 and the resistor layer films 11-1 to 11-4. To be more specific, the voltage between the gate and the source of each of the TFTs 26-1 to 26-4 is divided by each of the capacitors 28-1 to 28-4 and the capacitance between the gate and the source of each of the TFTs 26-1 to 26-4 so as to provide the current-voltage characteristics D1 to D4, in which current does not flow rapidly through each of the TFTs 26-1 to 26-4 unless the voltage between the gate and the source of each of the TFTs 26-1 to 26-4 is not increased to exceed the voltage value V1. If voltage V2 is applied to the circuit shown in FIG. 19, the current flowing through the circuit shown in FIG. 19 is determined in accordance with the resistance value of each of the resistance layer films 11-1 to 11-4 connected to the control electrode segments 3-1, 3-2, 3-3 and 3-4.

Where a uniform black color is displayed within the pixel included in the display device comprising the circuit shown in FIG. 19, the signal voltage V1 shown in FIG. 20 is applied simultaneously to the control electrode segments 3-1, 3-2, 3-3 and 3-4. Upon application of the signal voltage V1, current rapidly flows into the TFTs 26-1 to 26-4. As a result, the potential of each of the control electrode segments 3-1, 3-2, 3-3 and 3-4 is lowered to reach a negative potential so as to cause the black fine particles 6A to be collected on the control electrode segments 3-1, 3-2, 3-3 and 3-4, thereby achieving a black color display on the pixel.

Where an intermediate color tone is displayed in the display device comprising the circuit shown in FIG. 19 by utilizing the time constant τ as described previously in conjunction with FIG. 15, a signal voltage V2 is applied to the circuit shown in FIG. 19 after the initialization. By the application of the signal voltage V2, the potential of each of the control electrode segments 3-1, 3-2, 3-3 and 3-4 is lowered in accordance with each of the current-voltage characteristics D1 to D4. As a result, the black fine particles 6A are partly collected on the control electrode segments 3-1, 3-2, 3-3 and 3-4. It follows that the pixel of an intermediate color tone is displayed as a whole. If the current-voltage characteristics D1 to D4 are selected, the potential of each of the control electrode segments 3-1, 3-2, 3-3 and 3-4 can be changed and the potential change can be controlled by appropriate selection of the current-voltage characteristics D1 to D4, so that an intermediate color tone can be displayed with a good display state.

### Eleventh Embodiment

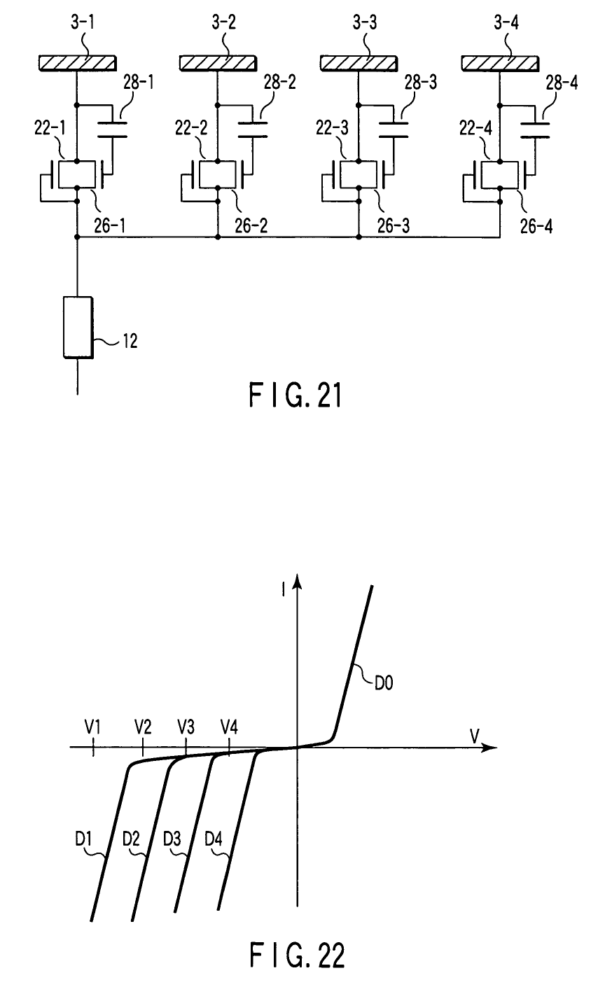

A display device according to an eleventh embodiment of the present invention, which permits uniformly displaying the black color within the pixel, will now be described with reference to FIGS. 21 and 22.

In order to display the black color uniformly during the display stage of the intermediate color tone, diodes comprised of the TFTs 22-1 to 22-4 and the TFTs 26-1 to 26-4 are connected in parallel in opposite directions as shown in FIG. 21. Also, the capacitors 28-1 to 28-4 having different capacitance C1 to C4 are connected to the gates of one of the TFTs 26-1 to 26-4. The circuit exhibits the current-voltage characteristics D1 to D4 as shown in FIG. 22. To be more specific, where the output voltage of the switching element 12 is negative, voltage values V2 to V4 at which current begins to flow rapidly through the TFTs 26-1 to 26-4 differ from each other, and the TFTs 26-1 to 26-4 are rendered conductive in accordance with these different voltage values V1 to V4.

For display a black color, the output voltage of the switching element 12 is set at V1. As a result, current flows sufficiently through all the control electrode segments 3-1, 3-2, 3-3 and 3-4, and these control electrode segments 3-1, 3-2, 3-3 and 3-4 are made to bear the same potential.

Where an intermediate color tone is displayed in the circuit shown in FIG. 21, the amplitude of the voltage signal during the ON time period Tn or Tn+1 is controlled as shown in FIG. 15 so as to display the intermediate color tone. To be more specific, any of voltages V2, V3, V4 and V0 shown in FIG. 22 is selected so as to control the value of the current supplied into the control electrode segments 3-1, 3-2, 3-3 and 3-4. In accordance with the current value, the voltage value given by the switching element 12 is instantly applied to the control electrode segments 3-1, 3-2, 3-3 and 3-4. As a result, the area of the electrode surface to which the particles are attached can be changed so as to make it possible to control the display of the intermediate color tone.

The present invention is not limited to the embodiments described above. It is possible to modify the constituents of the present invention within the technical scope of the present invention in the stage of working the technical idea of the present invention. For example, in the embodiments described above, an insulating resin layer may be etched so as to partition the pixels. However, the method of forming the pixel is not limited to the method noted above. It is also possible to seal the dispersion liquid within a capsule made of a transparent film and to arrange on the substrate the capsules having the dispersion liquid sealed therein. It is also possible to achieve various inventions by suitably combining a plurality of the constituents disclosed in the embodiments described above. For example, it is possible to delete some constituents from all the constituents disclosed in the embodiments described above. Further, it is possible to combine some constituents disclosed in the different embodiments of the present invention described above.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

1. An electrophoretic display device, comprising:
a first substrate;
a second substrate arranged to face the first substrate with a gap therebetween;
a dispersion liquid including an insulating liquid and electrophoretic fine particles dispersed in the insulating liquid, said dispersion liquid being applied in the gap;
first and second control electrode segments formed on the first substrate;
a counter electrode segment formed on the second substrate; and
a voltage applying circuit configured to apply a voltage to the control electrode segments and the counter electrode segment so as to produce first and second potential changes on the first and second control electrode segments, respectively.

2. The electrophoretic display device according to claim 1, wherein said counter electrode segment is opaque and formed on the second substrate.

3. The electrophoretic display device according to claim 1, further comprising a third control electrode segment, the second control electrode segment being positioned between the first control electrode segment and the third control electrode segment, and the voltage applying circuit producing a third potential change different from the first and second potential changes on the third control electrode segments.

4. The electrophoretic display device according to claim 1, wherein the voltage applying circuit includes a first impedance element, having an impedance, connected to the first control electrode segment and a voltage source for applying the voltage to the second control electrode segment and to the first control electrode segment through said first impedance element.

5. The electrophoretic display device according to claim 1, wherein the voltage applying circuit includes first and second impedance elements, having first and second impedances, connected to the first and second control electrode segments, respectively, and a voltage source for applying the voltage to the first and second control electrode segments through the first and second impedance elements.

6. The electrophoretic display device according to claim 1, wherein the voltage applying circuit includes lines through which the voltage is applied, the second impedance element includes at least one of a stray capacitance and a line resistance formed in the lines.

7. The electrophoretic display device according to claim 1, wherein the first impedance element is formed on the first substrate.

8. The electrophoretic display device according to claim 5, wherein the first and second control electrode segments are so positioned as to have first and second distances between the first and second control electrode segments and the counter electrode, respectively, the first distance is smaller than the second distance, and the first impedance is larger than the second impedance.

9. The electrophoretic display device according to claim 1, wherein the voltage applying circuit includes first and second resistor layers having different resistances and connected to the first and second control electrode segments, respectively, and a voltage source for applying the voltage to the first and second control electrode segments through the first and second resistor layers.

10. The electrophoretic display device according to claim 1, wherein the voltage applying circuit includes first and second capacitor layers having different capacitances and connected to the first and second control electrode segments, respectively, and a voltage source for applying the voltage to the first and second control electrode segments through the first and second capacitor layers.

11. The electrophoretic display device according to claim 10, wherein a common dielectric film is formed between the counter electrode segment and the first and second control electrode segments and has first and second regions facing to the first and second control electrode segments, and the first and second regions of the common dielectric film have different thicknesses.

12. The electrophoretic display device according to claims 1, wherein the insulating liquid is transparent.

13. An electrophoretic display device, comprising:
a first substrate;
a second substrate arranged to face the first substrate with a gap therebetween;
a dispersion liquid including an insulating liquid and electrophoretic fine particles dispersed in the insulating liquid, the dispersion liquid being applied in the gap;
first and second control electrode segments formed on the first substrate;
a counter electrode segment formed on the second substrate; and
a voltage applying circuit configured to apply a voltage to the control electrode segments and the counter electrode segment so as to produce first and second potential changes on the first and second control electrode segments, respectively,
said voltage applying circuit including:
first and second impedance elements having first and second impedances and connected to the first and second control electrode segments, respectively;
a first switching element connected to the first and second control electrode segments through the first and second impedance elements;
a switching control section configured to control the switching element; and
a voltage source for applying voltage between the first and second control electrode segments and the counter electrode segment via the switching element and the first and second impedance elements.

14. The electrophoretic display device according to claim 13, wherein each of the first and second impedance elements includes an active element configured to control the impedances.

15. The electrophoretic display device according to claim 13, wherein each of the first and second impedance elements includes a thin film transistor.

16. The electrophoretic display device according to claim 13, further comprising a common dielectric film formed between the first and second control electrode segments and the counter electrode segment, said common dielectric film serving to impart the first impedance between the first control electrode segment and the counter electrode segment and to impart the second impedance differing from the first impedance between the second control electrode segment and the counter electrode segment.

17. The electrophoretic display device according to claim 16, wherein the common dielectric film includes first and second regions, which are faced to the first and second control electrode segments and has different thicknesses, respectively.

18. The electrophoretic display device according to claim 16, wherein the dielectric film includes first and second regions, which are faced to the first and second control electrode segments and have first and second thicknesses, respectively, and have a dielectric constant smaller than that of the insulating liquid, the first and second control electrode segments are so positioned as to have first and second distances between the first and second control electrode segments and the counter electrode, respectively, and the first distance is smaller than the second distance.

19. The electrophoretic display device according to claim 13, wherein the switching control section controls a on-time period during which the switching element is kept turned on in accordance with a color tone to be displayed on the display device.

20. The electrophoretic display device according to claim 13, further comprising third and fourth control electrode segments formed on the first substrate, the voltage applying circuit including a second switching element that is commonly connected to the third and fourth control electrode segments, and the switching control section permitting the first and second switching elements to be turned on at a different timing.

21. The electrophoretic display device according to claim 13, wherein the first and second impedance elements are rendered conductive upon application of a voltage having a prescribed polarity, and different impedances are imparted to the first and second impedance elements upon application of voltage of the opposite polarity so as to permit current of different current values to be supplied to the first and second control electrode segments.

22. A method of driving an electrophoretic display device, said electrophoretic display device comprising:
a first substrate;
a second substrate arranged to face the first substrate with a gap provided therebetween;
a dispersion liquid including an insulating liquid and electrophoretic fine particles dispersed in the insulating liquid, said dispersion liquid being applied in the gap;
first and second control electrode segments formed on the first substrate; and
a counter electrode segment formed on the second substrate;
said driving method comprising
applying a voltage to the first and second control electrode segments and the counter electrode segment so as to produce first and second potential changes on the first and second control electrode segments.
